(19) United States
(12) Patent Application Publication
(10) Pub. No.: US 2015/0123587 A1
(43) Pub. Date: May 7, 2015

(54) ENCODER, MOTOR WITH ENCODER, AND SERVO SYSTEM

(71) Applicant: KABUSHIKI KAISHA YASKAWA DENKI, Kitakyushu-shi (JP)

(72) Inventors: Yasushi YOSHIDA, Kitakyushu-shi (JP); Yasuhiro MATSUTANI, Kitakyushu-shi (JP); Shiro YOSHIDOMI, Kitakyushu-shi (JP); Hiroshi TAKADA, Kitakyushu-shi (JP); Yuji ARINAGA, Kitakyushu-shi (JP); Ikuma MUROKITA, Kitakyushu-shi (JP); Masanobu HARADA, Kitakyushu-shi (JP); Hiroki KONDO, Kitakyushu-shi (JP)

(73) Assignee: KABUSHIKI KAISHA YASKAWA DENKI, Kitakyushu-shi (JP)

(21) Appl. No.: 14/532,005

(22) Filed: Nov. 4, 2014

(30) Foreign Application Priority Data
Nov. 5, 2013 (JP) 2013-229838

(51) Int. Cl. G01D 5/347; G05B 1/04; H02K 11/00

(52) U.S. Cl. CPC G01D 5/3473; G01D 5/34746; H02K 11/0026; G05B 1/04
USPC 318/640; 250/231.1; 310/68 B; 310/12.19

(57) ABSTRACT

An encoder includes a plurality of slit tracks, a point light source, a first light-receiving array, and a second light-receiving array. The plurality of slit tracks respectively comprises a plurality of reflection slits arranged along a measurement direction. The point light source is configured to emit diffusion light to the plurality of slit tracks. The first light-receiving array is configured to receive light reflected by the slit track comprising an incremental pattern, and is disposed at a position in a first direction than the point light source. The second light-receiving array is configured to receive light reflected by the slit track comprising an incremental pattern that differs in pitch from the slit track corresponding to the first light-receiving array, and is disposed at a position in a second direction than the point light source. The second direction forms an angle θ with respect to the first direction.

### CROSS-REFERENCE TO RELATED APPLICATION

The present application claims priority from Japanese Patent Application No. 2013-229838, which was filed on Nov. 5, 2013, the disclosure of which is incorporated herein by reference in its entirety.

### BACKGROUND OF THE INVENTION

1. Field of the Invention

The present disclosure relates to an encoder, a motor with an encoder, and a servo system.

2. Description of the Related Art

A reflection type encoder is known.

### SUMMARY OF THE INVENTION

According to one aspect of the disclosure, there is provided an encoder comprising a plurality of slit tracks, a point light source, a first light-receiving array, and a second light-receiving array. The plurality of slit tracks respectively comprises a plurality of reflection slits arranged along a measurement direction. The point light source is configured to emit diffusion light to the plurality of slit tracks. The first light-receiving array is configured to receive light reflected by the slit track comprising an incremental pattern, and is disposed at a position in a first direction than the point light source. The second light-receiving array is configured to receive light reflected by the slit track comprising an incremental pattern that differs in pitch from the slit track corresponding to the first light-receiving array, and is disposed at a position in a second direction than the point light source. The second direction forms an angle θ with respect to the first direction.

According to another aspect of the disclosure, there is provided an encoder comprising a plurality of slit tracks, a point light source, a plurality of first light-receiving arrays, and a second light-receiving array. The plurality of slit tracks respectively comprises a plurality of reflection slits arranged along a measurement direction. The point light source is configured to emit diffusion light to the plurality of slit tracks. The plurality of first light-receiving arrays is configured to respectively receive light reflected by a plurality of the slit tracks respectively comprising incremental patterns that differ in pitch. The second light-receiving array is configured to receive light reflected by the slit track comprising an absolute pattern, and is disposed between any one of the plurality of first light-receiving arrays and the point light source.

According to another aspect of the disclosure, there is provided an encoder, comprising a plurality of slit tracks, means for emitting diffusion light, means for receiving light reflected by the slit track comprising an incremental pattern, and means for receiving light reflected by the slit track comprising an incremental pattern that differs in pitch from the slit track corresponding to the means for receiving light reflected by the slit track comprising the incremental pattern. The plurality of slit tracks respectively comprises a plurality of reflection slits arranged along a measurement direction. The means for receiving light reflected by the slit track comprising an incremental pattern, is disposed at a position in a first direction than the point light source. The means for receiving light reflected by the slit track comprising an incremental pattern that differs in pitch from the slit track corresponding to the means for receiving light reflected by the slit track comprising the incremental pattern, is disposed at a position in a second direction than the point light source, the second direction forming an angle θ with respect to the first direction.

According to another aspect of the disclosure, there is provided a motor with an encoder comprising a linear motor or a rotary motor, and the above-described encoder. A mover moves with respect to a stator in the linear motor. A rotor rotates with respect to a stator in the rotary motor. The encoder is configured to detect at least one of a position and a velocity of the mover or the rotor.

According to another aspect of the disclosure, there is provided a servo system comprising a linear motor or a rotary motor, the above-described encoder, and a controller. A mover moves with respect to a stator in the linear motor. A rotor rotates with respect to a stator in the rotary motor. The encoder is configured to detect at least one of a position and a velocity of the mover or the rotor. The controller is configured to control the liner motor or the rotary motor based on a detection result of the encoder.

According to another aspect of the disclosure, there is provided an encoder comprising a plurality of slit tracks, a point light source, a first light-receiving array, and a second light-receiving array. The plurality of slit tracks respectively comprises a plurality of reflection slits arranged along a measurement direction. The point light source is configured to emit diffusion light to the plurality of slit tracks. The first light-receiving array is configured to receive light reflected by the slit track comprising an incremental pattern. The second light-receiving array is configured to receive light reflected by the slit track comprising an incremental pattern that differs in pitch from the slit track corresponding to the first light-receiving array.

### BRIEF DESCRIPTION OF THE DRAWINGS

FIG. 1 is an explanatory view for explaining a servo system related to an embodiment.

FIG. 2 is an explanatory view for explaining an encoder related to the embodiment.

FIG. 3 is an explanatory view for explaining a disk related to the embodiment.

FIG. 4 is an explanatory view for explaining a slit track related to the embodiment.

FIG. 5 is an explanatory view for explaining an optical module and a light-receiving array related to the embodiment.

FIG. 6 is an explanatory view for explaining a position data generating part related to the embodiment.

FIG. 7 is an explanatory view for explaining an irregular reflection caused by an unevenness of the disk surface related to the embodiment.

FIG. 8 is an explanatory view for explaining a directivity of the irregular reflection components caused by convex parts.

FIG. 9 is an explanatory view for explaining an intensity distribution of the irregular reflection components as viewed from a positive direction along an X axis.

FIG. 10 is an explanatory view for explaining an intensity distribution of the irregular reflection components as viewed from a positive direction along a Z axis.

FIG. 11 is an explanatory view for explaining an optical module and a light-receiving array related to a modification.

FIG. 12 is an explanatory view for explaining an optical module and a light-receiving array related to another modification.

FIG. 13 is an explanatory view for explaining an optical module and a light-receiving array related to yet another modification.

FIG. 14 is an explanatory view for explaining an optical module and a light-receiving array related to yet another modification.

FIG. 15 is an explanatory view for explaining an optical module and a light-receiving array related to yet another modification.

FIG. 16 is an explanatory view for explaining an optical module and a light-receiving array related to yet another modification.

FIG. 17 is an explanatory view for explaining an optical module and a light-receiving array related to yet another modification.

FIG. 18 is an explanatory view for explaining an optical module and a light-receiving array related to yet another modification.

### DETAILED DESCRIPTION OF THE EMBODIMENTS

The following describes an embodiment with reference to accompanying drawings.

Note that the encoder related to the embodiment described hereinafter is applicable to various types of encoders, such as a rotary type and a linear type. In the following, the embodiments are described using the rotary-type encoder as an example to ensure ease of encoder understanding. In a case where the embodiments are to be applied to another encoder type, it is possible to apply the type by adding appropriate changes, such as changing the object to be measured from a rotary-type disk to a linear scale, and thus detailed descriptions thereof are omitted.

### 1. Servo System

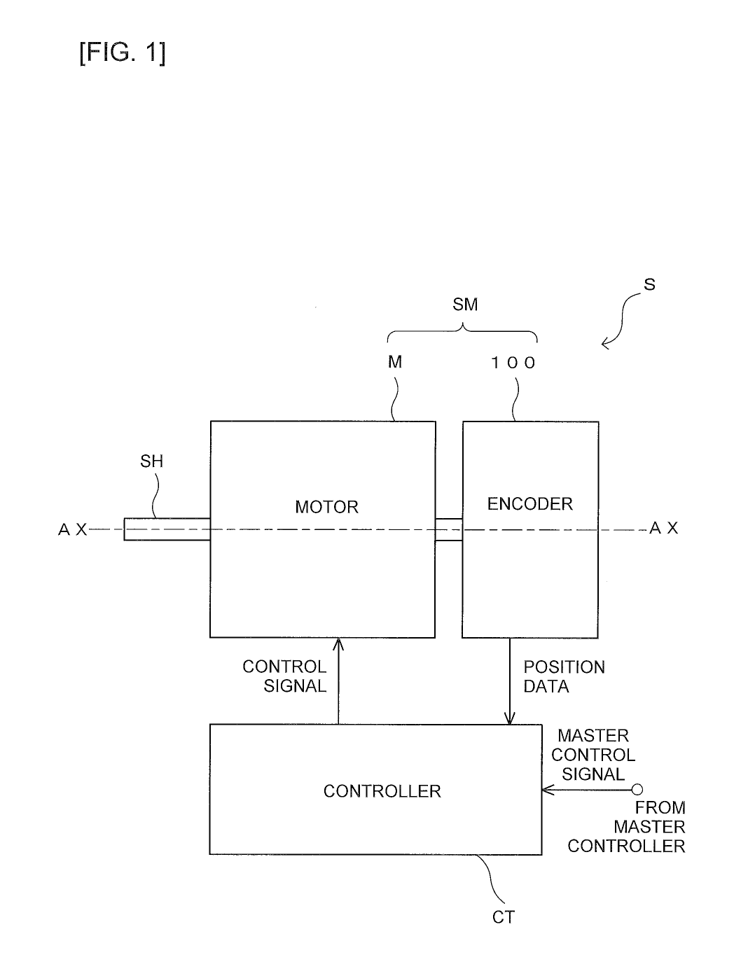

First, the configuration of a servo system related to this embodiment will be described with reference to FIG. 1. As shown in FIG. 1, the servo system S comprises a servo motor SM and a controller CT. The servo motor SM comprises an encoder 100 and a motor M.

The motor M is an example of a power generation source not including the encoder 100. The motor M is a rotary-type motor in which a rotor (not shown) rotates with respect to a stator (not shown), and outputs a rotational force by rotating a shaft SH fixed to the rotor around an axis AX.

Further, the motor M alone is sometimes referred to as a servo motor, but, in this embodiment, the configuration including the encoder 100 is referred to as the servo motor SM. That is, the servo motor SM corresponds to one example of a motor with an encoder. The following, for convenience of explanation, describes a case where the motor with an encoder is a servo motor controlled so as to follow target values, such as position and velocity values, but the motor is not necessarily limited to a servo motor. In a case where the output of the encoder is used for display only, for example, the motor with an encoder also includes motors used in a system other than a servo system, as long as an encoder is attached.

The motor M is not particularly limited as long as it is a motor in which the encoder 100 is capable of detecting position data and the like, for example. Further, the motor M is not limited to an electric motor that uses electricity as a power source, and it may be a motor that uses, for example, another power source, such as a hydraulic motor, a pneumatic motor, and a steam motor. However, for convenience of explanation, the following describes a case where the motor M is an electric motor.

The encoder 100 is connected to the side opposite the rotational force output side of the shaft SH of the motor M. Note that the connected side is not necessarily limited to the opposite side, allowing the encoder 100 to be connected to the rotational force output side of the shaft SH. The encoder 100 detects a position of the motor M (also referred to as a rotational angle) by detecting the position of the shaft SH (rotor), and outputs position data representing the position.

The encoder 100 may detect at least one of a velocity of the motor M (also referred to as rotation speed, angular velocity, and the like) and an acceleration of the motor M (also referred to as rotation acceleration, angular acceleration, and the like) in addition to or in place of the position of the motor M. In this case, the velocity and the acceleration of the motor M can be detected by, for example, obtaining the first derivative or the second derivative of the position with respect to time, or counting a detection signal (an incremental signal described later, for example) for a predetermined period of time. For convenience of explanation, the following describes the embodiment with the physical quantity detected by the encoder 100 as the position.

The controller CT acquires position data output from the encoder 100, and controls the rotation of the motor M based on the position data. Consequently, in this embodiment where an electric motor is used as the motor M, the controller CT controls the rotation of the motor M by controlling the current, voltage, or the like to be applied to the motor M based on position data. Furthermore, it is also possible for the controller CT to control the motor M by acquiring a master control signal from a master controller (not shown) so that a rotational force capable of achieving a position and the like represented by the master control signal is output from the shaft SH of the motor M. Note that, in a case where the motor M uses another power source, such as a hydraulic, pneumatic, or steam motor, it is possible for the controller CT to control the rotation of the motor M by controlling the supply of the power source.

### 2. Encoder

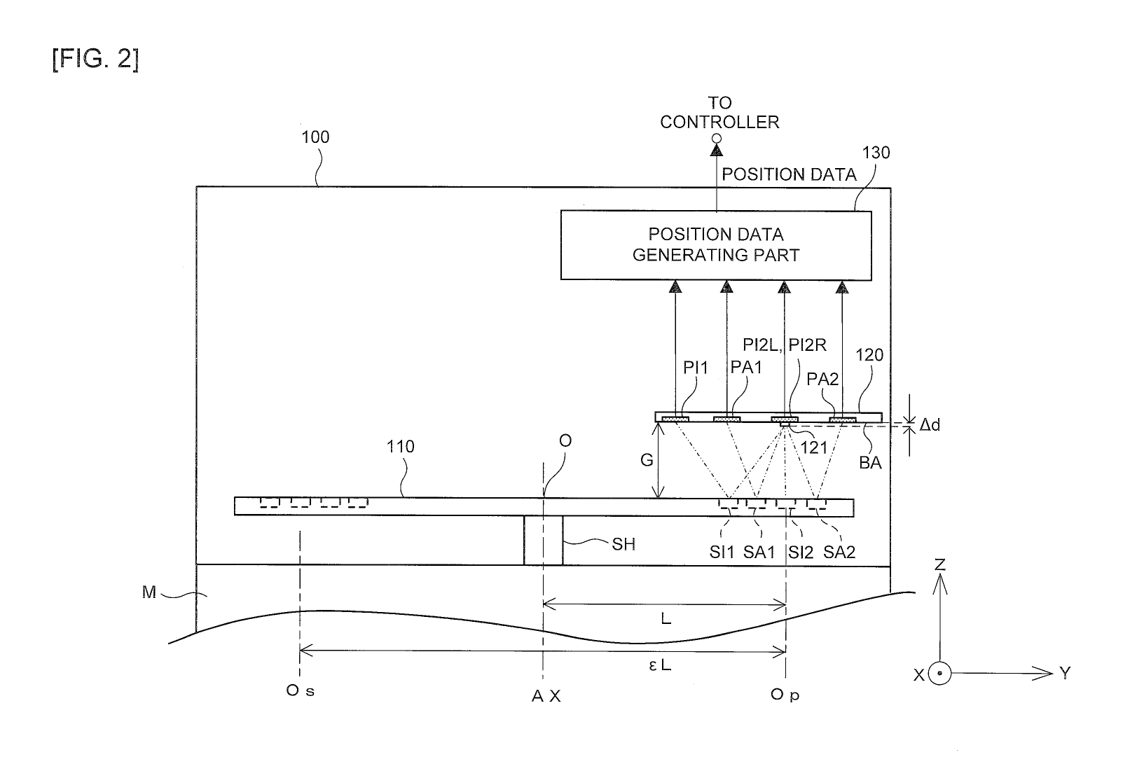

Next, the encoder 100 related to this embodiment will be described. As shown in FIG. 2, the encoder 100 comprises a disk 110, an optical module 120, and a position data generating part 130.

Here, for convenience of explanation of a structure of the encoder 100, directions, such as upward and downward directions, are defined and suitably used as follows. In FIG. 2, the direction in which the disk 110 faces the optical module 120, that is, the positive direction along the Z axis, is referred to as “upward” and the negative direction along the Z axis is referred to as “downward.” Note that the directions vary according to the attachment mode of the encoder 100, and the positional relationship of each configuration of the encoder 100 is not limited.

### 2-1. Disk

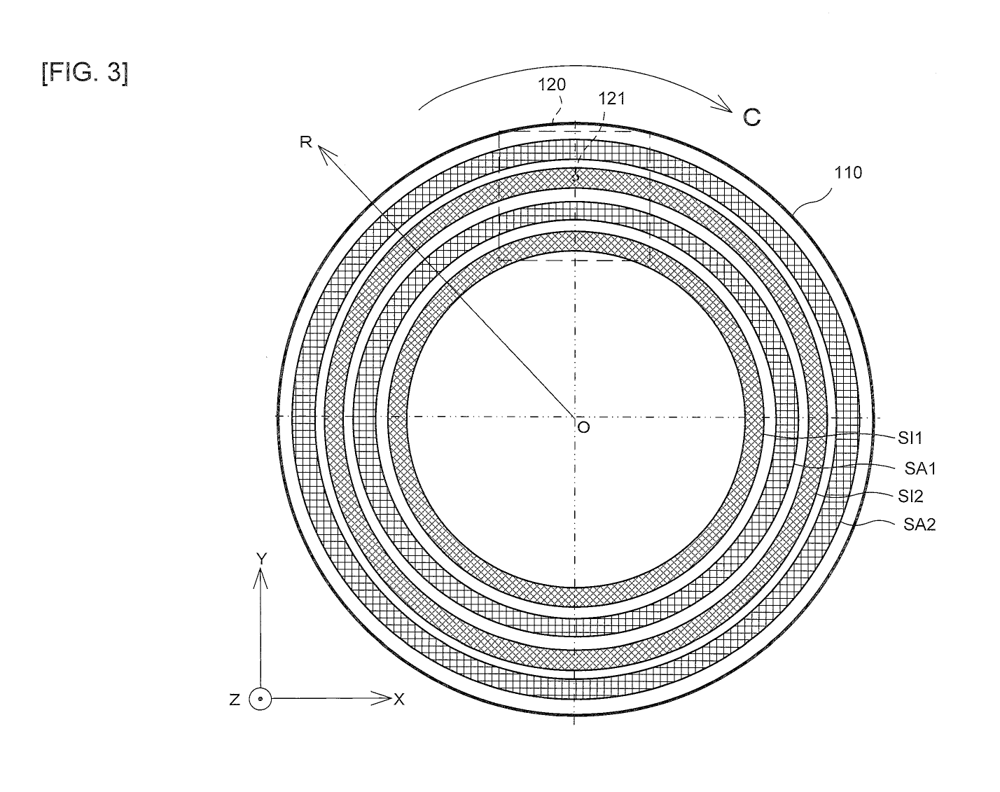

The disk 110 is formed into the shape of a circular plate as shown in FIG. 3, and disposed so that a disk centre O substantially agrees with the axis AX. The disk 110 is connected to the shaft SH of the motor M, and rotates by the rotation of the shaft SH. Note that, in this embodiment, explanation is given with the disk 110 in the shape of a circular plate as an example of an object to be measured that measures the rotation of the motor M. However, it is also possible to use another member, such as an end surface of the shaft SH, for example, as an object to be measured. Further, while the disk 110 is directly connected to the shaft SH in the example shown in FIG. 2, the disk 110 may be connected via a connecting member such as a hub.

As shown in FIG. 3, the disk 110 comprises a plurality of slit tracks SA1, SA2, SI1, SI2. While the disk 110 rotates with the drive of the motor M, the optical module 120 is disposed fixedly while facing a portion of the disk 110. Consequently, the slit tracks SA1, SA2, SI1, SI2 and the optical module 120 move relatively to each other in the measurement direction (the direction of arrow C shown in FIG. 3; hereinafter suitably referred to as “measurement direction C”) as the motor M is driven.

Here, the “measurement direction” is the measurement direction when the respective slit tracks formed on the disk 110 by the optical module 120 are optically measured. In a rotary-type encoder in which the object to be measured is the disk 110 as in this embodiment, the measurement direction agrees with the circumferential direction with the centre axis of the disk 110 as its centre, but is the direction along a linear scale in a linear-type encoder in which the object to be measured is a linear scale and a mover moves with respect to a stator. Note that the “centre axis” is the rotational axis of the disk 110, and agrees with the axis AX of the shaft SH in a case where the disk 110 and the shaft SH are coaxially connected.

### 2-2. Optical Detecting Mechanism

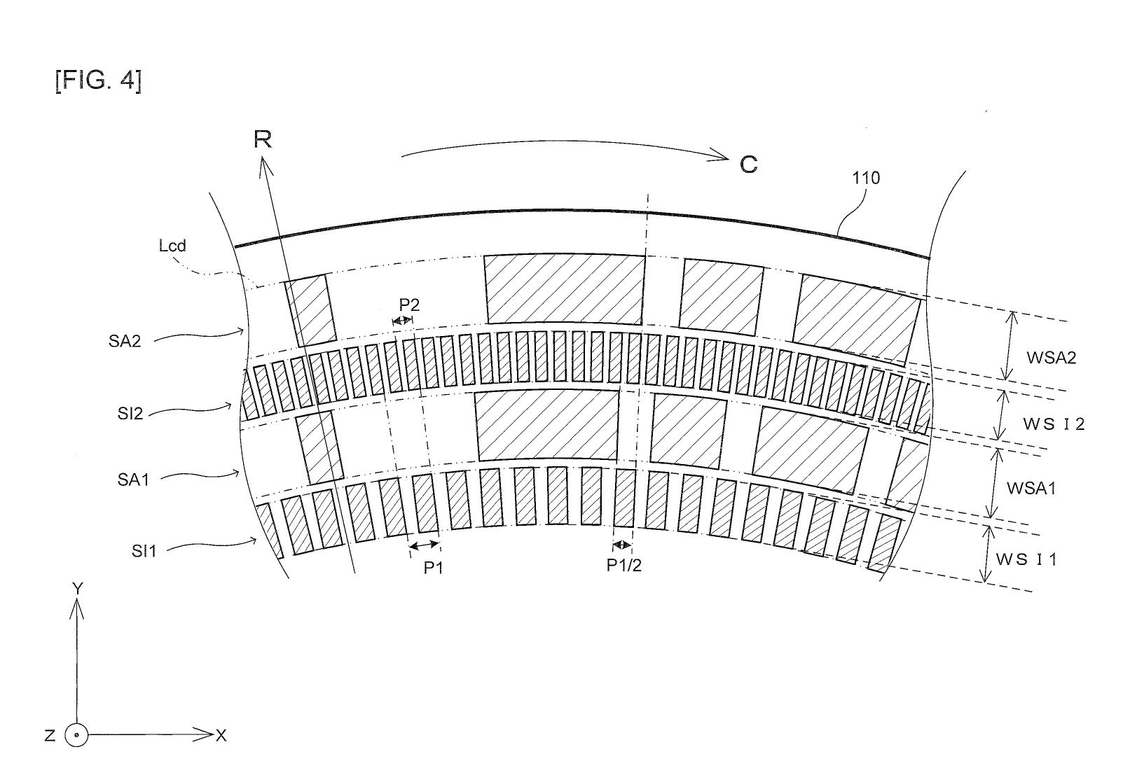

The optical detecting mechanism comprises the slit tracks SA1, SA2, SI1, SI2 and the optical module 120. The respective slit tracks are formed as tracks disposed in a ring shape with the disk centre O as its centre on the upper surface of the disk 110. Each of the slit tracks comprises a plurality of reflection slits (the sections shaded by slashes in FIG. 4) arranged side by side across the entire circumference of the track along the measurement direction C. Each reflection slit reflects light irradiated from a light source 121. Note that the light source 121 corresponds to one example of means for emitting diffusion light to a plurality of slit tracks.

### 2-2-1. Disk

The disk 110 is formed by a material that reflects light, such as metal, for example. Then, a material with low reflectance (such as chromium oxide, for example) is disposed onto sections where light is not to be reflected on the surface of the disk 110 by a coating process or the like, thereby forming reflection slits in sections where the material is not disposed. Note that the reflection slits may also be formed by creating a coarse surface on the sections where light is not to be reflected by sputtering or the like, thereby reducing reflectance.

Further, the material, manufacturing method, and the like of the disk 110 are not particularly limited. For example, the disk 110 may be formed using a material that transmits light, such as glass or transparent resin. In this case, the reflection slits can be formed by disposing a material that reflects light (such as aluminium, for example) on the surface of the disk 110 by vapour deposition or the like.

Four slit tracks are arranged on the upper surface of the disk 110 in the width direction (the direction of arrow R shown in FIG. 3; hereinafter suitably referred to as “width direction R”). Note that the “width direction” is the radial direction of the disk 110, i.e., the direction substantially orthogonal to the measurement direction C, and the length of each slit track along this width direction R corresponds to the width of each slit track. The four slit tracks are concentrically disposed in the order of SI1, SA1, SI2, SA2, from the inside toward the outside in the width direction R. In order to explain the respective slit tracks in further detail, FIG. 4 shows a partially enlarged view of the vicinity of an area of the disk 110 facing the optical module 120.

As shown in FIG. 4, a plurality of reflection slits included in the slit tracks SA1, SA2 is disposed along the entire circumference of the disk 110 so as to comprise an absolute pattern in the measurement direction C.

Note that the “absolute pattern” is a pattern in which the positions, proportions, and the like of the reflection slits within an angle in which the light-receiving arrays of the optical module 120 described later face each other are uniquely defined within one rotation of the disk 110. That is, for example, if the motor M is in a certain angular position in the case of the example of the absolute pattern shown in FIG. 4, a combination of bit patterns resulting from detection or non-detection by each of the plurality of light-receiving elements of the light-receiving arrays facing each other uniquely represents the absolute position of the angular position. Note that the “absolute position” refers to an angular position with respect to the origin within one rotation of the disk 110. The origin is set in a suitable angular position within one rotation of the disk 110, and the absolute pattern is formed with this origin as a reference.

Note that, according to an example of this pattern, it is possible to generate a pattern that one-dimensionally represents the absolute position of the motor M by bits in the number of light-receiving elements of the light-receiving array. However, the absolute pattern is not limited to this example. For example, the pattern may be a pattern multi-dimensionally represented by bits in the number of light-receiving elements. Further, other than a predetermined bit pattern, the pattern may be a pattern in which a physical quantity, such as a phase or amount of light received by the light-receiving elements, changes so as to uniquely represent the absolute position, a pattern in which a code sequence of an absolute pattern modulates, or other various patterns.

Note that, according to this embodiment, the same absolute patterns are offset from each other by, for example, a length equivalent to one-half of one bit in the measurement direction C, forming the two slit tracks SA1, SA2. This offset amount is a value corresponding to, for example, half a pitch P1 of a reflection slit of the slit track SI1. If the slit tracks SA1, SA2 were not configured to be offset in this manner, possibilities such as the following exist. That is, if the absolute position is represented by a one-dimensional absolute pattern such as in this embodiment, the detection accuracy of the absolute position may decrease in the area of a change in the bit pattern resulting from the respective light-receiving elements of the light-receiving arrays PA1, PA2 being positioned facing the vicinity of an end area of the reflection slits. According to this embodiment, since the slit tracks SA1, SA2 are offset, the absolute position is calculated using the detection signal from the slit track SA2 or the opposite operation is performed when, for example, the absolute position by the slit track SA1 corresponds to a change point in the bit pattern. As a result, it is possible to improve the detection accuracy of the absolute position. Note that, while the amount of received light in the two light-receiving arrays PA1, PA2 needs to be uniform in the case of such a configuration, the two light-receiving arrays PA1, PA2 are disposed equidistant from the light source 121 according to this embodiment, making it possible to achieve the above described configuration.

Note that, instead of offsetting the respective absolute patterns of the slit tracks SA1, SA2 against each other, the light-receiving arrays PA1, PA2 respectively corresponding to the slit tracks SA1, SA2 may be offset against each other without offsetting the absolute patterns, for example.

On the other hand, a plurality of reflection slits included in the slit tracks SI1, SI2 is disposed along the entire circumference of the disk 110 so as to comprise an incremental pattern in the measurement direction C.

The “incremental pattern” is a pattern repeated regularly at a predetermined pitch, as shown in FIG. 4. Here, “pitch” refers to the disposed interval of the respective reflection slits of the slit tracks SI1, SI2 that comprise an incremental pattern. As shown in FIG. 4, the pitch of the slit track SI1 is P1, and the pitch of the slit track SI2 is P2. The pitch P1 and the pitch P2 differ from each other. The incremental pattern, unlike the absolute pattern that represents the absolute position by the bits corresponding to detection or non-detection by the plurality of light-receiving elements, represents the position of the motor M for each pitch or within one pitch by the sum of the detection signals resulting from at least one or more of the light-receiving elements. Consequently, the incremental pattern does not represent the absolute position of the motor M, but can represent the position with very high accuracy compared to the absolute pattern.

According to this embodiment, the pitch P1 of the slit track SH is set longer than the pitch P2 of the slit track SI2. According to this embodiment, each pitch is set so that P1=2×P2. That is, the number of reflection slits of the slit track SI2 is two times the number of the reflection slits of the slit track SI1. Nevertheless, the relationship of this slit pitch is not limited to this example, and can take various values, such as three times, four times, and five times, for example.

Note that, according to this embodiment, the minimum length of the reflection slits of the slit tracks SA1, SA2 in the measurement direction C agrees with the pitch P1 of the reflection slit of the slit track SI1. As a result, the resolution of the absolute signal based on the slit tracks SA1, SA2 agrees with the number of the reflection slits of the slit track SI1. Nevertheless, the minimum length is not limited to this example, and the number of the reflection slits of the slit track SI1 is preferably set greater than or equal to the resolution of the absolute signal.

### 2-2-2. Optical Module

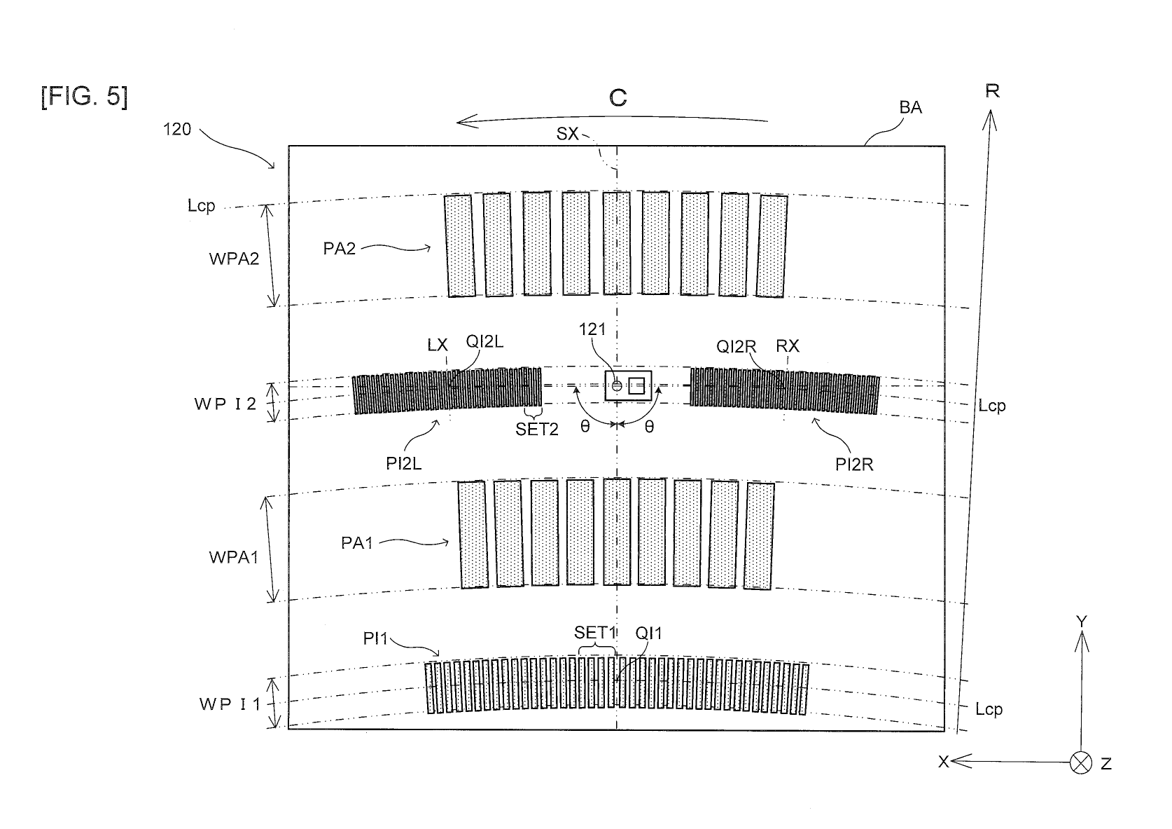

The optical module 120, as shown in FIG. 2 and FIG. 5, is formed as one substrate BA parallel to the disk 110. With this arrangement, the encoder 100 can be thinned and the structure of the optical module 120 can be simplified. Consequently, the optical module 120 relatively moves with respect to the slit tracks SA1, SA2, SI1, SI2 in the measurement direction C, accompanying the rotation of the disk 110. Note that the optical module 120 does not necessarily need to be configured as one substrate BA, allowing each component to be configured as a plurality of substrates. In this case, these substrates may be collectively disposed. Further, the optical module 120 does not need to be in the form of a substrate.

The optical module 120, as shown in FIG. 2 and FIG. 5, comprises the light source 121, and a plurality of light-receiving arrays PA1, PA2, PI1, PI2L, PI2R on the surface of the substrate BA facing the disk 110.

As shown in FIG. 3, the light source 121 is disposed in a position facing the slit track SI2. Then, the light source 121 emits light onto the sections facing the four slit tracks SA1, SA2, SI1, SI2 that pass through the positions facing the optical module 120.

The light source 121 is not particularly limited as long as it is a light source capable of irradiating the irradiation area with light, allowing use of a light emitting diode (LED), for example. The light source 121 is particularly configured as a point light source in which no optical lens or the like is disposed, and emits diffusion light from a light-emitting part. Note that, when referring to a “point light source,” the light source does not need to be strictly a point, and the light may be emitted from a finite emission surface as long as the light source is regarded as capable of emitting diffusion light from a substantially point-like position from the standpoint of design and operation principles. Further, the “diffusion light” is not limited to light emitted from a point light source toward all directions, but includes light that is diffused and emitted toward a certain finite direction. That is, the term “diffusion light” used here includes any light that comprises more diffusibility than parallel light. By using a point light source in this manner, it is possible for the light source 121 to substantially uniformly irradiate the four slit tracks SA1, SA2, SI1, SI2 that pass through the positions facing thereto with light. Further, collecting and diffusing of light by an optical element are not performed, and therefore errors and the like caused by the optical element are unlikely to occur, making it possible to increase the straightness of light toward the slit tracks.

The plurality of the light-receiving arrays is disposed along the circumference of the light source 121, and comprises a plurality of light-receiving elements (the sections shaded by dots in FIG. 5), each which receives light reflected by the reflection slits of the slit tracks correspondingly associated thereto. The plurality of light-receiving elements is arranged side by side along the measurement direction C, as shown in FIG. 5.

Note that the light emitted from the light source 121 is diffusion light. Consequently, the image of the slit tracks projected onto the optical module 120 is an image magnified by a predetermined magnifying power ε in accordance with the optical path length. That is, as shown in FIG. 4 and FIG. 5, given WSA1, WSA2, WSI1, WSI2 as the respective lengths of the slit tracks SA1, SA2, SI1, SI2 in the width direction R and WPA1, WPA2, WPI1, WPI2 as the lengths of the shapes of the reflection light projected onto the optical module 120 in the width direction R, WPA1, WPA2, WPI1, WPI2 are lengths corresponding to ε times WSA1, WSA2, WSI1, WSI2. Note that this embodiment shows an example in which the lengths of the light-receiving elements of the respective light-receiving arrays in the width direction R are set substantially equal to the shape of the respective slits projected onto the optical module 120, as shown in FIG. 5. However, the lengths of the light-receiving elements in the width direction R are not necessarily limited to this example.

Similarly, the measurement direction C in the optical module 120 is also the shape of the measurement direction C in the disk 110 projected onto the optical module 120, that is, the shape affected by the magnifying power ε. In order to make understanding easier, the following provides a detailed explanation using the measurement direction C in the position of the light source 121 as an example, as shown in FIG. 2. The measurement direction C in the disk 110 is circular in shape, with the axis AX as a centre. Conversely, the centre of the measurement direction C projected onto the optical module 120 is located in a position separated from an optical centre Op, which is in a position within the plane of the disk 110 on which the light source 121 is disposed, by a distance εL. The distance εL is a distance L between the axis AX and optical centre Op magnified by the magnifying power ε. This position is conceptually illustrated in FIG. 2 as a measurement centre Os. Consequently, the measurement direction C in the optical module 120 is on a line having the measurement centre Os separated by the distance εL from the optical centre Op on a line on which the optical centre Op and the axis AX are located in the direction of the axis AX as a centre and the distance εL as a radius.

In FIG. 4 and FIG. 5, the correspondence relationship of the measurement direction C in the disk 110 and the optical module 120 is represented by arc-shaped lines Lcd, Lcp. The line Lcd shown in FIG. 4 represents a line on the disk 110 along the measurement direction C, and the line LCP shown in FIG. 5 represents a line on the substrate BA along the measurement direction C (the line Lcd projected onto the optical module 120).

As shown in FIG. 2, given G as a gap length between the optical module 120 and the disk 110, and Δd as an amount of protrusion of the light source 121 from the substrate BA, the magnifying power ε is expressed by the following (Formula 1).

ε=(2G−Δd)/(G−Δd) (Formula 1)

As each light-receiving element, a photodiode, for example, can be used. However, the light-receiving element is not limited to a photodiode and is not particularly limited as long as it is capable of receiving light emitted from the light source 121 and converting the light into an electric signal.

The light-receiving arrays in this embodiment are disposed correspondingly to the four slit tracks SA1, SA2, SI1, SI2. The light-receiving array PA1 is configured to receive the light reflected by the slit track SA1, and the light-receiving array PA2 is configured to receive the light reflected by the slit track SA2. Further, the light-receiving array PI1 is configured to receive the light reflected by the slit track SI1, and the light-receiving arrays PI2L, PI2R are configured to receive the light reflected by the slit track SI2. While the light-receiving arrays PI2L, PI2R are divided in the middle, they correspond to the same track. In this manner, the number of light-receiving arrays corresponding to one slit track is not limited to one, allowing a plurality.

The light source 121, the light-receiving arrays PA1, PA2, and the light-receiving arrays PI1, PI2L, PI2R are disposed in the positional relationship shown in FIG. 5. The light-receiving arrays PA1, PA2 corresponding to the absolute pattern are disposed sandwiching the light source 121 in the width direction R. In this example, the light-receiving array PA1 is disposed on the inner circumference side, and the light-receiving array PA2 is disposed on the outer circumference side. According to this embodiment, the distances between the light-receiving arrays PA1, PA2 and the light source 121 are substantially equal. Then, the plurality of light-receiving elements included in the light-receiving arrays PA1, PA2 is arranged side by side at a certain pitch along the measurement direction C (the line Lcp). The light-receiving arrays PA1, PA2 respectively receive the reflection light from the slit tracks SA1, SA2, thereby generating an absolute signal comprising a bit pattern in the number of light-receiving elements. Note that the light-receiving arrays PA1, PA2 correspond to one example of the third light-receiving array described in claim 7, and the light-receiving array PA1 corresponds to one example of the second light-receiving array described in claim 8.

The light-receiving array PI1 corresponding to the incremental pattern is disposed further on the centre axis side than the light source 121 so as to sandwich the light-receiving array PA1 with the light source 121. Further, the light-receiving arrays PI2L, PI2R corresponding to the incremental pattern are disposed sandwiching the light source 121 in the measurement direction C. Specifically, the light-receiving arrays PI2L, PI2R are axisymmetrically disposed with a line parallel to the Y axis, which includes the light source 121, serving as the axis SX of symmetry, and each of the light-receiving arrays PA1, PA2, PI1 form an axisymmetrical shape about the above described symmetrical axis SX. The light source 121 is disposed between the light-receiving arrays PI2L, PI2R disposed as one track in the measurement direction C.

Note that, from a different view, it can be said that the light-receiving array PI1 and the light-receiving array PI2 are disposed in directions that differ from each other, with the light source 121 as reference. That is, given a “first direction” (the negative direction along the Y axis in this example) as the direction of the disposed area of the light-receiving array PI1, with the light source 121 as reference (as viewed from the light source 121; hereinafter the same), the respective disposed areas of the light-receiving arrays PI2L, PI2R, with the light source 121 as reference, are in a “second direction” (the positive and negative directions along the X axis in this example) that forms an angle θ with respect to the above described first direction. Note that the “angle θ” is an angle formed by the above described first direction and second direction, and does not include 0 degrees. According to this embodiment, as shown in FIG. 5, the light-receiving array PI1 and each of the light-receiving arrays PI2L, PI2R are disposed so that the angle θ is substantially 90 degrees.

Note that the angle θ does not necessarily need to be substantially 90 degrees, allowing the angle θ to be any other angle as long as the light-receiving array PI1 and the light-receiving array PI2 are not disposed in the same direction, with the light source 121 as reference (where the angle θ is substantially 0 degrees). However, to ensure that the light-receiving array PI1 and the light-receiving array PI2 are not disposed in opposite directions, with the light source 121 as reference (where the angle θ is substantially 180 degrees), the light-receiving arrays PI1, PI2 are preferably disposed so that the above described second direction inclines with respect to the above described first direction. Note that “inclines” here refers to a line including the above described first direction and a line including the above described second direction not being parallel, indicating a state where the angle θ is neither substantially 0 degrees nor substantially 180 degrees.

Note that, according to this embodiment, each position serving as reference when indicating the direction of the disposed area of each light-receiving array is, for example, a centre position of the area occupied by the light-receiving array. That is, the respective positions serving as references for the light-receiving array PI1, the light-receiving array PI2L, and the light-receiving array PI2R are: a centre position QI1, which is a point of intersection of the line Lcp that passes through the width direction centre thereof and the axis SX of symmetry; a centre position QI2L, which is a point of intersection of the line Lcp that passes through the width direction centre thereof and a centre axis LX which bisects the light-receiving array PI2L in the measurement direction; and a centre position QI2R, which is the point of intersection of the line Lcp that passes through the width direction centre thereof and a centre axis RX which bisects the light-receiving array PI2R in the measurement direction. However, the reference position when indicating the direction of the disposed area of each light-receiving array may be a position other than the above described centre position.

Note that the light-receiving array PI1 corresponds to one example of the first light-receiving array in claims 1 to 7, and also to one example of means for receiving light reflected by the slit track comprising an incremental pattern. Further, each of the light-receiving arrays PI2L, PI2R corresponds to one example of the second light-receiving array in claims 1 to 7, and also to one example of means for receiving light reflected by the slit track comprising an incremental pattern that differs in pitch from the slit track corresponding to means for receiving light reflected by the slit track comprising an incremental pattern. Further, both of the light-receiving arrays PI1, PI2 correspond to one example of the first light-receiving array in claim 8.

This embodiment illustrates a one-dimensional pattern as the absolute pattern, and therefore the light-receiving arrays PA1, PA2 corresponding thereto comprise a plurality (nine, for example, in this embodiment) of light-receiving elements arranged side by side along the measurement direction C (line Lcp) so as to respectively receive the light reflected by the reflection slits of the slit tracks SA1, SA2 correspondingly associated thereto. This plurality of light-receiving elements handles whether or not light is received as a bit as described above, and represents the absolute position of nine bits in total. Consequently, a light reception signal received by each of the plurality of light-receiving elements is handled independently in the position data generating part 130, and the absolute position encrypted (coded) into a serial bit pattern is decoded from the combination of these light reception signals. The light reception signal of the light-receiving arrays PA1, PA2 is referred to as an “absolute signal.” Note that, in a case where an absolute pattern that differs from that in this embodiment is used, the light-receiving arrays PA1, PA2 become a configuration corresponding to that pattern.

The light-receiving arrays PI1, PI2L, PI2R comprise a plurality of light-receiving elements arranged side by side along the measurement direction C (line Lcp) so as to respectively receive light reflected by the reflection slits of the slit tracks SI1, SI2 correspondingly associated thereto. First, the light-receiving array is explained using the light-receiving array PI1 as an example.

According to this embodiment, sets of a total of four light-receiving elements (represented by “SET1” in FIG. 5) are arranged side by side in one pitch (one pitch in the projected image; that is, ε×P1) of the incremental pattern of the slit track SI1, and sets of the four light-receiving elements are further arranged side by side in a plurality along the measurement direction C. Then, since the incremental pattern forms reflection slits repeatedly on a per pitch basis, each of the light-receiving elements generates a periodic signal of one period (referred to as 360° in terms of electric angle) in one pitch when the disk 110 rotates. Then, since four light-receiving elements are disposed in one set corresponding to one pitch, the light-receiving elements adjacent to each other in one set detect periodic signals comprising a phase difference of 90° from each other. The respective light reception signals are referred to as an A-phase signal, a B-phase signal (with a phase difference of 90° from the A-phase signal), a bar A-phase signal (with a phase difference of 180° from the A-phase signal), and a bar B-phase signal (with a phase difference of 180° from the B-phase signal).

The incremental pattern represents a position in one pitch, and therefore the signal in each phase in one set and the signal in each phase in another set corresponding thereto have values that change in the same manner. Consequently, the signals in the same phase are added across a plurality of sets. Consequently, from a large number of light-receiving elements of the light-receiving array PI1 shown in FIG. 5, four signals shifted from one another by a phase of 90° are detected.

On the other hand, the light-receiving arrays PI2L, PI2R are also configured in the same manner as the light-receiving array PI1. That is, sets of a total of four light-receiving elements (represented by “SET2” in FIG. 5) are arranged side by side in one pitch (one pitch in the projected image; that is, ε×P2) of the incremental pattern of the slit track SI2, and sets of four light-receiving elements are arranged side by side in a plurality along the measurement direction C. Consequently, four signals shifted from one another by a phase of 90° are respectively generated from the light-receiving arrays PI1, PI2L, PI2R. These four signals are referred to as “incremental signals.” Further, the incremental signals generated from the light-receiving arrays PI2L, PI2R corresponding to the slit track SI2 with a short pitch are referred to as “high incremental signals” since the resolution is high compared to other incremental signals, and the incremental signals generated by the light-receiving array PI1 corresponding to the slit track SI1 with a long pitch are referred to as “low incremental signals” since the resolution is low compared to other incremental signals.

Note that while this embodiment describes an illustrative scenario in which four light-receiving elements are included in one set corresponding to one pitch of the incremental pattern, and the light-receiving array PI2L and the light-receiving array PI2R each comprise sets with the same configuration, the number of light-receiving elements in one set is not particularly limited, such as a case where two light-receiving elements are included in one set, for example. Further, the light-receiving arrays PI2L, PI2R may be configured to acquire light reception signals in different phases.

### 2-3. Position Data Generating Part

The position data generating part 130 acquires two absolute signals, each comprising the bit pattern representing the absolute position, and high incremental signals and low incremental signals that include four signals shifted from one another by a phase of 90°, from the optical module 120, at the timing in which the absolute position of the motor M is measured. Then, based on the acquired signals, the position data generating part 130 calculates the absolute position of the motor M represented by these signals, and outputs position data representing the calculated absolute position to the controller CT.

Note that, as for the method for generating the position data by the position data generating part 130, various methods can be used without particular limitation. As an example, the following describes a case where the absolute position is calculated from the high incremental signal and the low incremental signal as well as the absolute signal, and the position data is then generated.

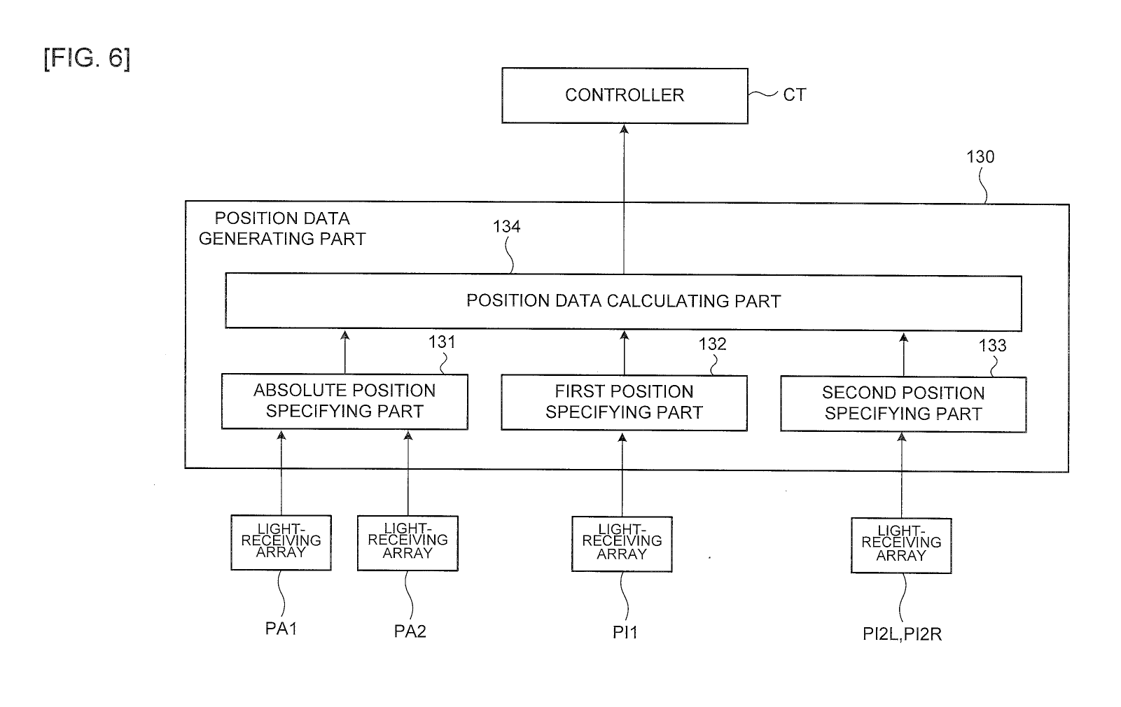

As shown in FIG. 6, the position data generating part 130 comprises an absolute position specifying part 131, a first position specifying part 132, a second position specifying part 133, and a position data calculating part 134. The absolute position specifying part 131 binarises each absolute signal from the light-receiving arrays PA1, PA2, and converts the signals into bit data representing the absolute position. Then, the absolute position specifying part 131 specifies the absolute position based on the correspondence relationship between predefined bit data and the absolute position.

On the other hand, of the low incremental signals of the respective four phases from the light-receiving array PI1, the first position specifying part 132 subtracts the low incremental signals with a phase difference of 180° from each other. By subtracting the signals with a phase difference of 180°, it is possible to cancel out the manufacturing errors, measurement errors, and the like of the reflection slit within one pitch. As described above, the signals resulting from the subtraction are referred to as a “first incremental signal” and a “second incremental signal” here. The first incremental signal and the second incremental signal comprise a phase difference of 90° from each other by electric angle (simply referred to as “A-phase signal,” “B-phase signal,” and the like). Then, the first position specifying part 132 specifies a position within one pitch from these two signals. The method for specifying a position within one pitch is not particularly limited. For example, in a case where the low incremental signal, which is a periodic signal, is a sinusoidal signal, an example of the above described specification method is to calculate an electric angle φ by performing the arc tangent operation on the result of division of the two sinusoidal signals in the A phase and B phase. Or, there is also a method for converting the two sinusoidal signals into an electric angle φ using a tracking circuit. Or, there is also a method for specifying an electric angle φ correspondingly associated with the values of signals in the A phase and B phase in a table created in advance. At this time, it is preferable for the first position specifying part 132 to convert the two sinusoidal signals in the A phase and B phase from analogue to digital on a per detection signal basis.

The position data calculating part 134 superimposes the position within one pitch specified by the first position specifying part 132 onto the absolute position specified by the absolute position specifying part 131. With this arrangement, it is possible to calculate an absolute position with higher resolution than an absolute position based on an absolute signal. According to this embodiment, the resolution of this calculated absolute position agrees with the number of slits of the slit track SI2 with a short pitch. That is, in this example, the resolution of the calculated absolute position is two times the resolution of an absolute position based on an absolute signal.

On the other hand, the second position specifying part 133 performs the same processing as the aforementioned first position specifying part 132 on the high incremental signals from the light-receiving arrays PI2L, PI2R, and specifies a highly accurate position within one pitch from the two signals. Then, the position data calculating part 134 superimposes the position within one pitch specified by the second position specifying part 133 onto the absolute position calculated based on the aforementioned low incremental signals. With this arrangement, it is possible to calculate an absolute position that has even higher resolution than the absolute position calculated based on low incremental signals.

The position data calculating part 134 performs multiplication processing on the absolute position thus calculated to further improve the resolution, and outputs the result as position data representing a highly accurate absolute position to the controller CT. The method for specifying a high resolution absolute position from a plurality of position data with different resolutions in this manner is referred to as the “stacking-up method.”

### 3. Examples of Advantages of this Embodiment

According to this embodiment, the encoder 100 comprises the light-receiving array PI1 configured to receive the light reflected by the slit track SI1 comprising an incremental pattern, and the light-receiving array PI2 configured to receive the light reflected by the slit track SI2 comprising an incremental pattern that differs in pitch from the slit track SI1. With this arrangement, it is possible to generate position data representing an absolute position with high resolution by the aforementioned stacking-up method, making it possible to achieve high resolution.

Further, according to this embodiment, the direction of the disposed area of the light-receiving array PI2 and the direction of the disposed area of the light-receiving array PI1, with the light source 121 as reference, form the angle θ, thereby achieving higher accuracy in addition to the aforementioned higher resolution. Note that to “achieve higher accuracy” refers to increasing the reliability of the detection signal by reducing noise and the like.

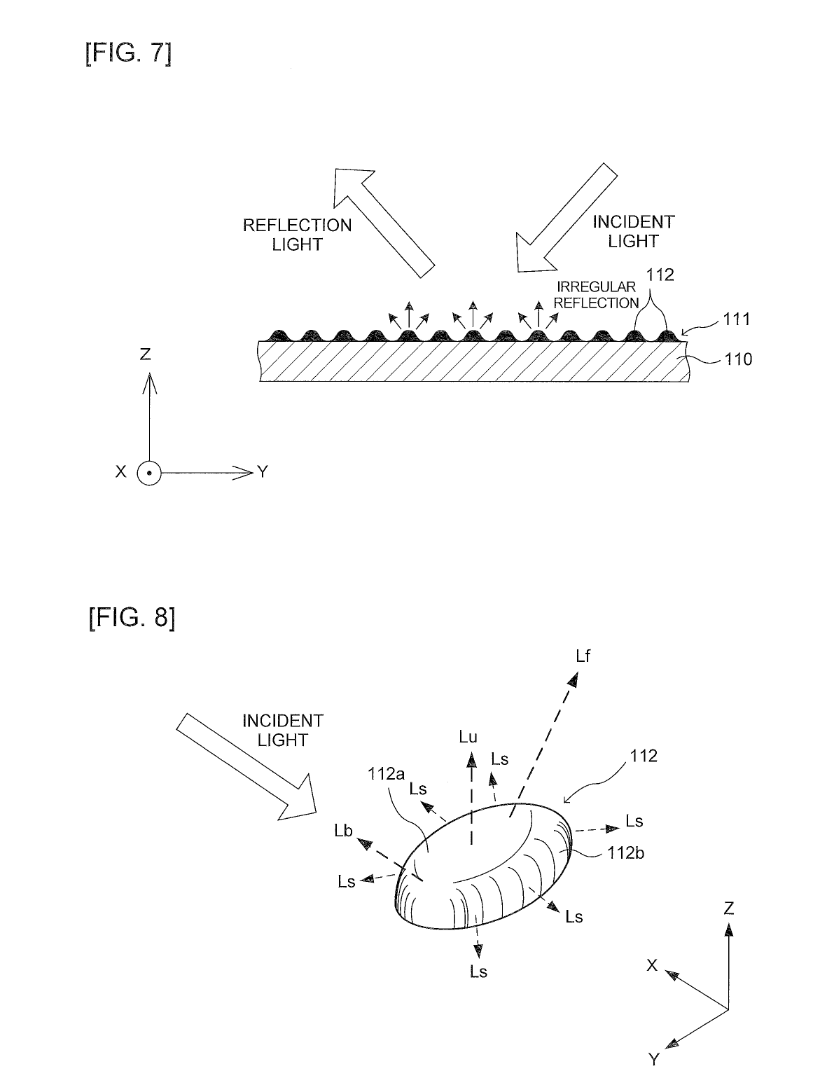

As shown in FIG. 7, a large amount of minute unevenness exists on the surface of a material 111 of the disk 110, which causes the light emitted from the light source 121 to produce irregular reflection (scattering) when reflected by the disk 110.

FIG. 8 conceptually shows an example of the shape of a convex part 112 in the minute unevenness of the material 111.

Note that, in FIG. 8, the length of each arrow of the irregular reflection component represents the size of intensity. In the example shown in FIG. 8, the convex part 112 comprises an upper surface 112a, and an inclined side surface 112b that surrounds the circumference of the upper surface 112a. The upper surface 112a, with its relatively flat shape, has a large surface area where the incident light is irradiated diagonally from above (the positive side along the Y axis and the positive side along the Z axis in this example), but the side surface 112b, being slanted, has a small surface area where the incident light is irradiated. As a result, the intensity of the irregular reflection component produced by the incident light is relatively high for a frontward scattering component Lf, an upward scattering component Lu, and a rearward scattering component Lb scattered by the upper surface 112a, and relatively low for a sideways scattering component Ls scattered by the side surface 112b in the circumferential direction, as shown in FIG. 8. Further, of the frontward scattering component Lf, the upward scattering component Lu, and the rearward scattering component Lb, the intensity of the frontward scattering component Lf scattered in the regular reflection direction is highest, and the intensity of upward scattering component Lu scattered upward and the rearward scattering component Lb scattered in the direction reverse from the advancing direction of the incident light is intermediate (higher than the sideways scattering component Ls). Consequently, the distribution of the irregular reflection components as a whole is dominant in the direction along the Y-Z plane.

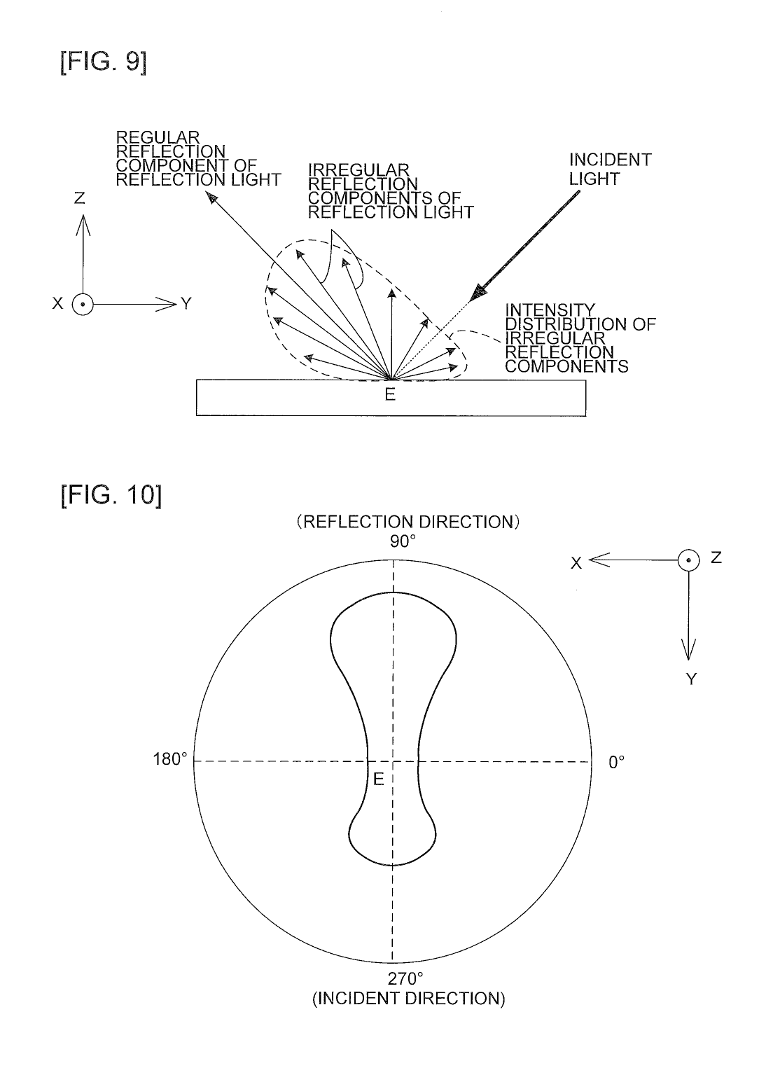

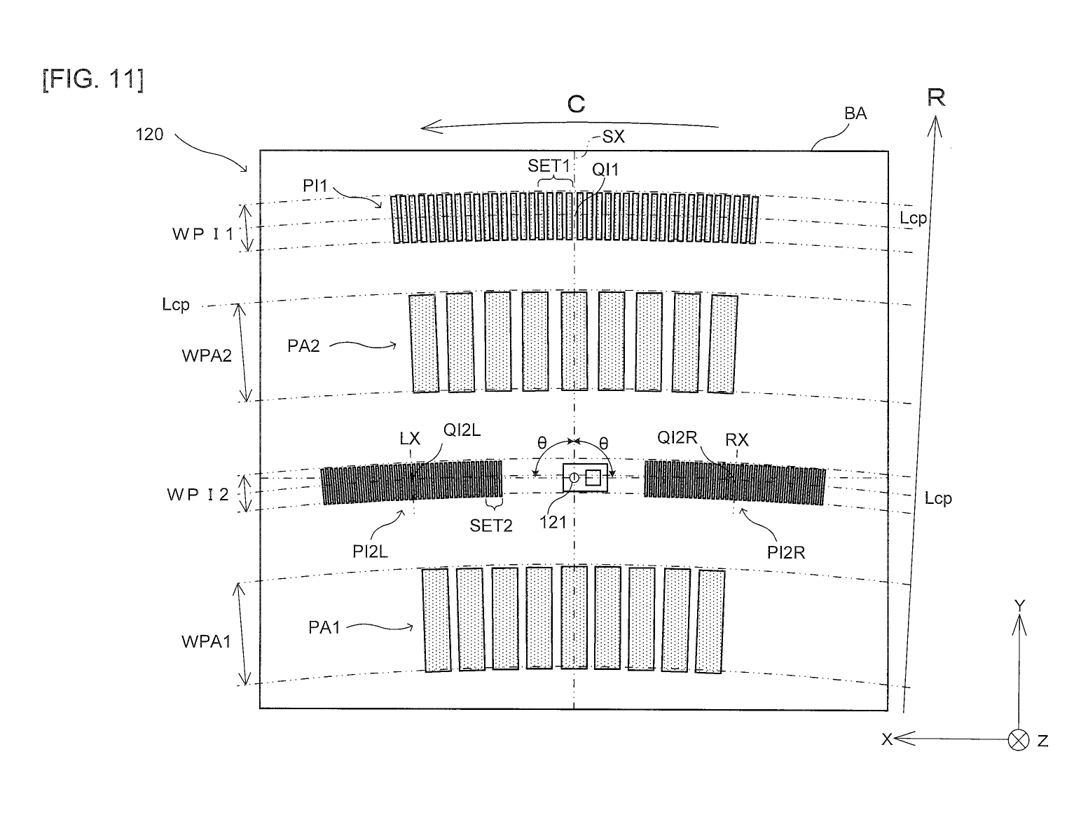

FIG. 9 shows the intensity distribution of the irregular reflection components as viewed from the positive direction along the X axis, and FIG. 10 shows the intensity distribution of the irregular reflection components as viewed from the positive direction along the Z axis. Note that the length of each arrow in FIG. 9 and the distance from point E in FIG. 10 represent the size of intensity, respectively. Due to the irregular reflection by the aforementioned convex part 112, the intensity distribution of the irregular reflection components on the surface of the disk 110 where a large number of minute convex parts 112 exists forms a shape that is longer in the direction along the plane which includes the advancing direction of the light (the Y-Z plane in this example), and comprises directivity in the direction along the Y axis as a whole, as shown in FIG. 9 and FIG. 10. More specifically, as shown in FIG. 10, this intensity distribution of the irregular reflection components is a substantially 8-shaped distribution wherein two circles arranged side by side in the advancing direction of the light are connected, with the reflection position E as the centre, and the circle on the advancing direction far side of the light in particular forms a distribution shape that is larger than the circle on the advancing direction near side. That is, in a case where two light-receiving arrays are disposed in the same direction, with the light source 121 as reference in the optical module 120, crosstalk in which, for example, the scattered light in the reflection light that should reach one light-receiving array reaches the other light-receiving array, occurs between both light-receiving arrays, causing noise. Then, the light-receiving array that is farther away from the light source 121 receives a greater amount of irregular reflection components of the light than the light-receiving array that is closer to the light source 121, sometimes producing even greater noise.

In particular, while both the light-receiving arrays PI1, PI2 receive the reflection light of the incremental pattern, both reflection lights are repetition lights repeated periodically. If the noise of one repetition light were superimposed onto the other repetition light, both lights would interfere with each other, producing even greater noise. Such noise may affect signal processing, such as multiplication.

According to this embodiment, the light-receiving array PI1 is disposed in an area of a predetermined direction, with the light source 121 as reference (an example of the first direction), and the light-receiving array PI2 is disposed in an area of a direction that forms the angle θ with respect to the above described predetermined direction, with the light source 121 as reference (an example of the second direction). That is, the disposed areas of both of the light-receiving arrays PI1, PI2 differ from each other in terms of direction from the light source 121. Then, the intensity distribution of the irregular reflection components of the light forms a shape that is longer in the direction along the plane that includes the advancing direction of the light as described above, and therefore the irregular reflection components decrease in a direction that differs from the advancing direction of the light. Consequently, with the disposed configuration in this embodiment, it is possible to decrease the irregular reflection components mutually received by the light-receiving arrays PI1, PI2. As a result, crosstalk such as that occurs between the light-receiving arrays PI1, PI2 described above can be suppressed, making it possible to decrease the effect on signal processing and increase reliability.

Further, according to the intensity distribution shape of the irregular reflection components of the light described above, the irregular reflection components of the light emitted from the light source 121 and received by predetermined light-receiving arrays are received in greater amounts by the light-receiving arrays disposed in the direction opposite the direction of the disposed area of the light-receiving arrays, with the light source 121 as reference (in other words, by the light-receiving arrays symmetrically disposed, sandwiching the light source 121) than the light-receiving arrays disposed in other directions (excluding those disposed in the same direction as the light-receiving arrays). Based on such circumstances, according to this embodiment, the light-receiving arrays PI1, PI2 are disposed so that the direction of the disposed area of the light-receiving array PI2, with the light source 121 as reference (an example of the second direction) is inclined with respect to the direction of the disposed area of the light-receiving arrays PI1, with the light source 121 as reference (an example of the first direction). With this arrangement, the light-receiving arrays PI1, PI2 can be disposed so that the angle θ is not substantially 180 degrees, making it possible to decrease the irregular reflection components mutually received by both of the light-receiving arrays and suppress the occurrence of crosstalk.

Furthermore, according to the intensity distribution shape of the irregular reflection components of the light described above, the irregular reflection components decrease in a direction that differs from the advancing direction of the light, reaching a minimum in the direction in which the angle is substantially 90 degrees. Based on such circumstances, according to this embodiment, the light-receiving array PI1 and the light-receiving array PI2 are disposed so that the above described angle θ is substantially 90 degrees. With this arrangement, the irregular reflection components mutually received by the light-receiving arrays PI1, PI2 can be suppressed to a minimum, making it possible to suppress the occurrence of crosstalk to the extent possible.

Furthermore, according to this embodiment, the light-receiving array PI2 is divided sandwiching the light source 121. Thus, in a case where the light-receiving array PI2 of the light-receiving arrays PI1, PI2 is divided sandwiching the light source 121, and the other light-receiving array PI1 is not divided along the circumference of the light source 121, each of the divided sections PI2L, PI2R of the light-receiving array PI2 divided and the light-receiving array PI1 have a positional relationship wherein the above described angle θ is necessarily substantially 90 degrees or close thereto. Consequently, it is possible to suppress the occurrence of crosstalk to the extent possible.

Further, as described above, in the two light-receiving arrays PA1, PA2 that output absolute signals, a bit pattern resulting from detection or non-detection by each of the plurality of light-receiving elements uniquely represents an absolute position. On the other hand, in the light-receiving arrays PI1, PI2 that output incremental signals, the detection signals resulting from the plurality of light-receiving elements corresponding in phase are added together to represent a position within one pitch. In terms of the properties of such signals, the light-receiving arrays PI1, PI2 require a relatively small amount of received light and, since the noise is averaged, have a relatively high resistance to noise, whereas the light-receiving arrays PA1, PA2 require an adequate amount of received light and have a relatively low resistance to noise.

Consequently, in a case where the amount of received light by the absolute is to be maintained and the noise effect on the absolute signals is to be suppressed, a configuration can be adopted in which the light-receiving array PA1 configured to receive light reflected by the slit track SA1 comprising the absolute pattern is disposed between the light-receiving array PI1 and the light source 121, as in this embodiment. With this arrangement, it is possible to dispose the light-receiving arrays PA1, PA2 near the light source 121 and maintain the amount of received light. Further, of the light-receiving arrays disposed in the same direction, with the light source 121 as reference, while the light-receiving array that is farther away from the light source receives a greater amount of irregular reflection components of the light than the light-receiving array that is closer to the light source as described above, according to this embodiment, the light-receiving array PI1 having a high resistance to noise is disposed in a position away from the light source 121 in the same direction, and the light-receiving array PA1 having a low resistance to noise is disposed in a position near the light source 121, thereby making it possible to suppress the noise effect resulting from the aforementioned irregular reflection components to a minimum.

Note that, furthermore, in the case of this embodiment, by disposing the light-receiving array PI1, which is an incremental light-receiving array having a small noise effect on final accuracy and a relatively high resistance to noise, in a position where it sandwiches another light-receiving array with the light source 121, the noise of the light-receiving array with a relatively large noise effect can be reduced and accuracy can be improved.

Furthermore, according to this embodiment, by disposing the light-receiving arrays PI2L, PI2R, wherein the noise affects accuracy relatively easily, in a direction that differs from other light-receiving arrays, with the light source 121 as reference as well, it is possible to reduce the amount of light of the irregular reflection itself that reaches the light-receiving arrays PI2L, PI2R, and further improve accuracy.

Generally, with the light-receiving array disposed away from the light source, the amount of received light is reduced. When the light-receiving surface area is increased in order to maintain the amount of received light, the junction capacitance of the respective light-receiving elements increases, decreasing signal responsiveness. Further, if the amount of received light is reduced, signal responsiveness similarly decreases even if the gain is increased on the circuit side.

On the other hand, in a case where a configuration is adopted in which the light-receiving array PA1 is disposed between the light receiving array PI1 and the light source 121, it is possible to suppress such a responsiveness reduction effect to a minimum. That is, because the signals acquired from the light-receiving arrays PI2L, PI2R have high resolution, the signals become highly periodic repetition signals compared to those of other light-receiving arrays, but the accuracy of the final absolute position is relatively highly affected by the responsiveness of the signals output from the light-receiving arrays PI2L, PI2R. Consequently, the disposed positions of the light-receiving arrays PI2L, PI2R are important factors in accuracy improvement. Further, the signals output from the light-receiving arrays PA1, PA2 represent a relatively low-accuracy absolute position within one rotation, as described above. These output signals also serve as the foundation of the final absolute position, and therefore precision and responsiveness are required for accuracy improvement. Consequently, the disposed positions of the light-receiving arrays PA1, PA2 also serve as important factors in accuracy improvement.

On the other hand, in a case where three types of light-receiving arrays (an example of the first to third light-receiving arrays) are disposed as in this embodiment, it becomes difficult to dispose all of the types of light-receiving arrays adjacent to the light source 121, and at least one type of light-receiving array sandwiches another light-receiving array with the light source 121. Based on such circumstances, according to this embodiment, the light-receiving array PA1 is disposed between the light-receiving array PI1 and the light source 121. As a result, it is possible to arrange the light-receiving arrays PA1, PA2 near the light-source 121 and also dispose the light-receiving arrays PI2L, PI2R, which are disposed in a direction that differs from the light-receiving array PI1, so that they do not sandwich another light-receiving array with the light source 121, making it possible to arrange them near the light source 121 as well. Thus, it is possible to arrange the light-receiving arrays PI2L, PI2R and the light-receiving arrays PA1, PA2, which have a relatively large effect on the accuracy of the absolute position, near the light source 121, making it possible to improve responsiveness and, further, the accuracy of the absolute position.

On the one hand, a portion of the reflection light from the slit tracks may be reflected on the surface of each light-receiving element included in each light-receiving array. When this reflection light is reflected once again by the slit tracks and received by another light-receiving array, crosstalk occurs, causing noise. Then, in a case where a plurality of light-receiving arrays is disposed along the circumference of the light source 121 as in this embodiment, the light emitted from the light source 121 is diffusion light and therefore the light reflected on the surface of the light-emitting array and reflected once again by the slit track is received in relatively large amounts by the light-receiving array disposed on the outside of that light-receiving array (the side opposite the light source 121). As a result, in a case where there is a light-receiving array disposed sandwiching another light-receiving array with the light source 121 as in this embodiment, the light-receiving array receives reflection components by the light-receiving array nearer the light source 121, possibly producing even greater noise. On the other hand, in a case where there is not another light-receiving array between the light-receiving array and the light source 121, the effect of the reflection components by the light-receiving array decreases.

Consequently, by disposing the light-receiving array PA1 between the light-receiving array PI1 and the light source 121 as in this embodiment, the light-receiving arrays PI2L, PI2R and the light-receiving arrays PA1, PA2, which have a relatively large noise effect, can be disposed so that another light-receiving array does not exist between them and the light source 121. This makes it possible to reduce the noise resulting from the reflection components of the light-receiving arrays and improve accuracy.

Further, the detection error resulting from the eccentricity of the disk 110 generally tends to be dependent on the radius of the slit track, increasing when the radius is small and decreasing when the radius is large. Consequently, in a case where the robustness with respect to the eccentricity of a high incremental signal is to be enhanced, a configuration can be adopted in which the light-receiving array PI1 is disposed further on the centre axis side than the light source 121, as in this embodiment. With this arrangement, the light-receiving arrays PI2L, PI2R are disposed further on the side opposite the centre axis than the light-receiving array PI1 (i.e., the outer circumference side), and the slit track SI2 with a short pitch (i.e., with many slits) is disposed on the outer circumference side on the disk 110, making it possible to increase the radius of the slit track SI2. As a result, the detection error resulting from the eccentricity of the light-receiving arrays PI2L, PI2R that output high incremental signals can be decreased, and the robustness with respect to eccentricity can be enhanced. Further, a larger pitch of the slit track SI2 with many slits can be maintained.

### 4. Modifications

The above has described in detail an embodiment while referring to accompanying drawings. Nevertheless, the spirit and the scope of the present disclosure set forth in the claims are not limited to the embodiment described above. The fact that various changes, modifications, and combinations can be extrapolated within the true spirit and scope will be apparent to persons with ordinary skill in the art affiliated with the embodiments. Consequently, any techniques resulting from these changes, modifications, and combinations are also naturally affiliated with the spirit and scope of the disclosure.

### 4-1. Disposing the Light-Receiving Array PI1 Along the Outer Circumference

Further, while the above described embodiment has described an illustrative scenario in which the light-receiving array PI1 is disposed further on the centre axis side than the light source 121, the light-receiving array PI1 may be disposed further on the side opposite the centre axis than the light source 121 (the outer circumference side), as shown in FIG. 11, for example. In this case as well, similar to the above described embodiment, the light-receiving array PI1 and each of the light-receiving arrays PI2L, PI2R are disposed so that the above described angle θ is substantially 90 degrees. Although not shown, in this case, the four slit tracks are disposed in the order of SA1, SI2, SA2, SI1, from the inside toward the outside in the width direction R on the disk 110. The configuration in the above described embodiment is preferably adopted in a case where the robustness with respect to the eccentricity of the high incremental signal is to be enhanced, and this configuration is preferably adopted in a case where the robustness with respect to the eccentricity of the low incremental signal is to be enhanced.

### 4-2. Disposing the Light-Receiving Array PI1 in a Divided Manner, and the Light-Receiving Array PI2 Along the Outer Circumference

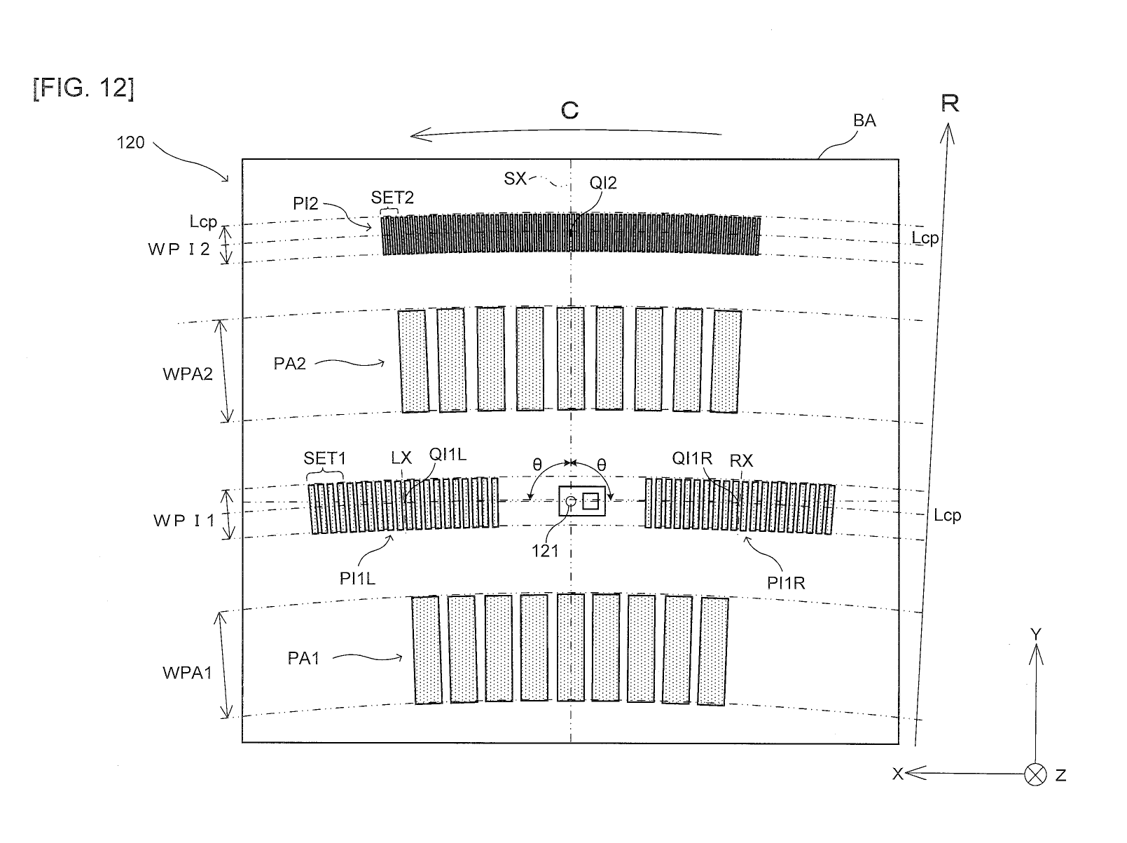

Further, while the above described embodiment has described an illustrative scenario in which the light-receiving array PI2 is divided in the measurement direction, the light-receiving array PI1 may be divided in the measurement direction, as shown in FIG. 12, for example. In this example, the light-receiving arrays PI1L, PI1R are disposed sandwiching the light source 121 in the measurement direction, and the light-receiving array PI2 is disposed further on the side opposite the centre axis than the light source 121 so as to sandwich the light-receiving array PA2 with the light source 121. The point that the light-receiving arrays PI1L, PI1R are configured to receive the light reflected by the slit track SI1 comprising an incremental pattern of the pitch P1, and the light-receiving array PI2 is configured to receive the light reflected by the slit track SI2 comprising an incremental pattern of the pitch P2 is the same as the above described embodiment. Although not shown, in this case, the four slit tracks are disposed in the order of SA1, SI1, SA2, SI2, from the inside toward the outside in the width direction R on the disk 110.

According to this modification, the disposed area of the light-receiving array PI1 and the disposed area of the light-receiving array PI2 are positioned in directions that differ from each other, with the light source 121 as reference. That is, the light-receiving array PI2 is disposed in an area of a predetermined direction, with the light source 121 as reference (an example of the first direction; the positive direction along the Y axis in this example), and the respective light-receiving arrays PI1L, PI1R are disposed in an area of a direction that forms the above described angle θ with respect to the above described predetermined direction, with the light source 121 as reference (an example of the second direction; the positive and negative directions along the X axis in this example). According to this modification, as shown in FIG. 12, the light-receiving array PI2 and each of the light-receiving arrays PI1L, PI1R are disposed so that the above described angle θ is substantially 90 degrees.

Note that, according to this modification, the position that serves as reference when indicating the direction of the disposed area of each light-receiving array is as follows. That is, the respective positions that serve as references for the light-receiving array PI2, the light-receiving array PI1L, and the light-receiving array PI1R are: the centre position QI2, which is a point of intersection of the line Lcp that passes through the width direction centre thereof and the axis SX of symmetry; the centre position QI1L, which is a point of intersection of the line Lcp that passes through the width direction centre thereof and the centre axis LX which bisects the light-receiving array PI1L in the measurement direction; and a centre position QI1R, which is the point of intersection of the line Lcp that passes through the width direction centre thereof and the centre axis RX which bisects the light-receiving array PI1R in the measurement direction. Note that, according to this modification, the light-receiving array PI2 corresponds to one example of the first light-receiving array in claims 1 to 7, and also to one example of means for receiving light reflected by the slit track comprising an incremental pattern. Further, each of the light-receiving arrays PI1L, PI1R corresponds to one example of the second light-receiving array, and also to one example of means for receiving light reflected by the slit track comprising an incremental pattern that differs in pitch from the slit track corresponding to means for receiving light reflected by the slit track comprising an incremental pattern.

In a case where this configuration is adopted, it is possible to enhance the robustness with respect to displacement in the rotating direction of the optical module 120, in addition to the same advantages as those in the above described embodiment. That is, the position data generating part 130 first calculates the absolute position by superimposing the position within one pitch specified based on the low incremental signal of the light-receiving array PI1 onto the absolute position specified based on the absolute signals of the light-receiving arrays PA1, PA2 as described above. As a result, the signal phase error between the light-receiving array PI1 and each of the light-receiving arrays PA1, PA2 is preferably as small as possible. According to this modification, the light-receiving arrays PI1L, PI1R are disposed on the inside of the light-receiving arrays PA1, PA2, making it possible to decrease the distance in the direction along the Y axis between the light-receiving array PI1 and the light-receiving array PA2 in comparison to the above described embodiment. As a result, the displacement amount of the light-receiving array PA2 in a case where the optical module 120 is displaced in the rotating direction can be decreased, making it possible to decrease the phase error between the light-receiving array PI1 and the light-receiving array PA2. Furthermore, in a case where the distance between the light-receiving array PI1 and the light-receiving array PA1 is configured to be substantially equal to the distance between the light-receiving array PI1 and the light-receiving array PA2, it is possible to minimize the displacement amounts of both the light-receiving arrays PA1, PA2 and, with both displacement amounts becoming equal, eliminate the unbalance of the phase error, thereby minimizing the effect on signal processing. Consequently, the configuration in this modification is extremely advantageous in a case where the robustness with respect to the displacement of the optical module 120 in the rotating direction needs to be improved.

### 4-3. Disposing the Light-Receiving Array PI1 in a Divided Manner, and the Light-Receiving Array PI2 Along the Inner Circumference

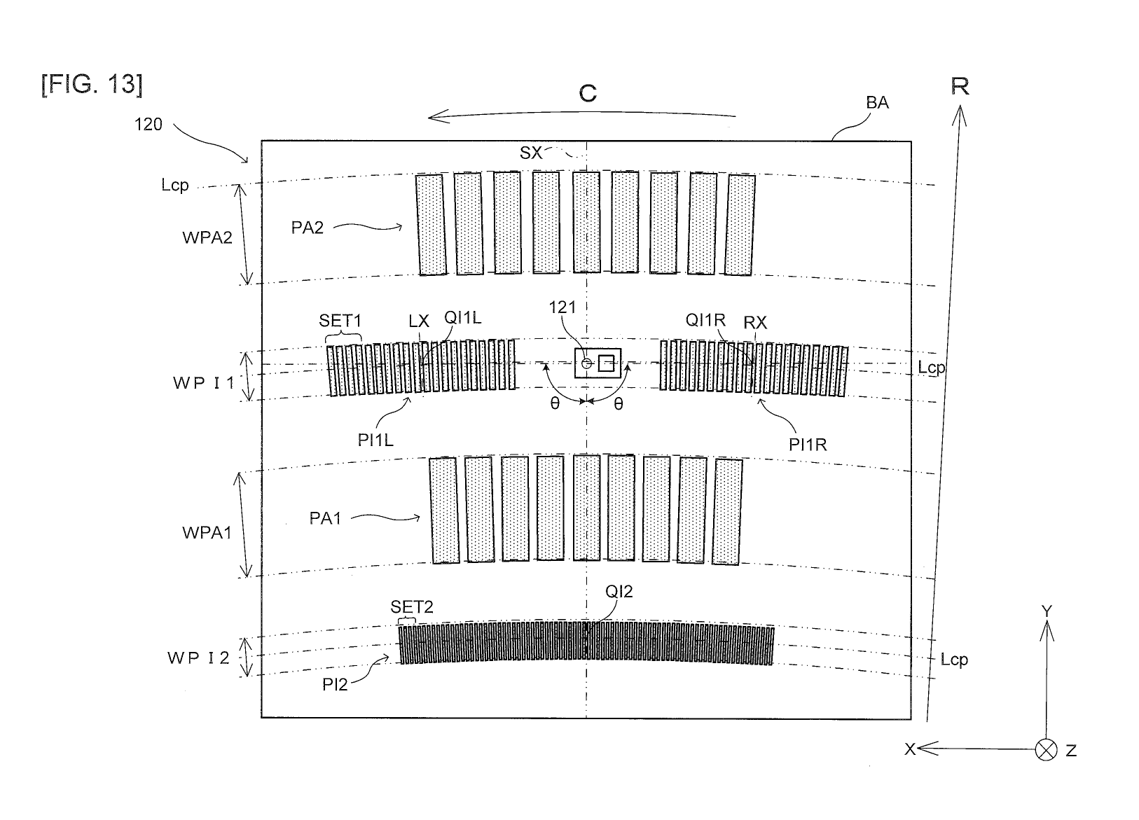

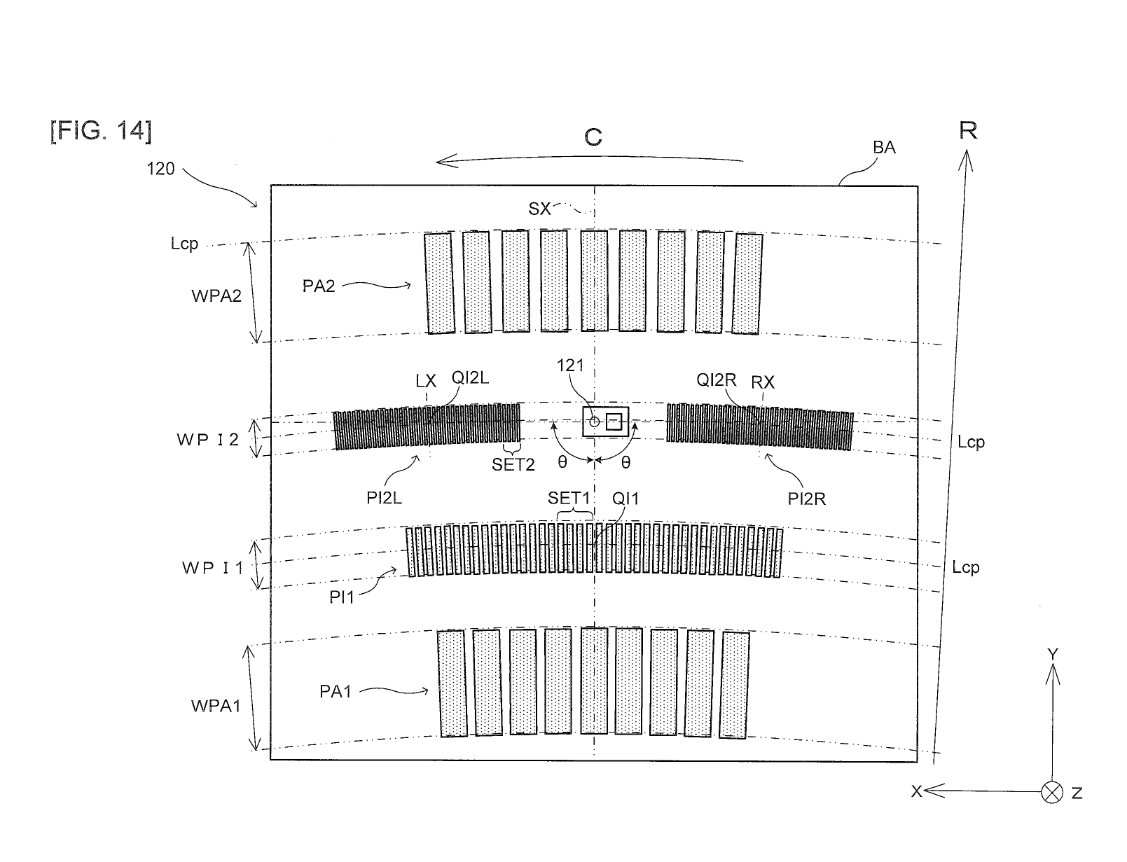

While the above described modification (4-2) has described an illustrative scenario in which the light-receiving array PI2 is disposed further on the side opposite the centre axis than the light source 121, the light-receiving array PI2 may be disposed further on the centre axis side than the light source 121 (the inner circumference side), as shown in FIG. 13, for example. In this case as well, the light-receiving array PI2 and each of the light-receiving arrays PI1L, PI1R are disposed so that the above described angle θ is substantially 90 degrees. Although not shown, in this case, the four slit tracks are disposed in the order of SI2, SA1, SI1, SA2, from the inside toward the outside in the width direction R on the disk 110. The configuration in the above described modification (4-2) is preferably adopted in a case where the robustness with respect to the eccentricity of the high incremental signal is to be enhanced, and this configuration is preferably adopted in a case where the robustness with respect to the eccentricity of the low incremental signal is to be enhanced.

### 4-4. Disposing the Light-Receiving Arrays PI1, PI2 on the Inside, and the Light-Receiving Array PI2 in a Divided Manner

Further, while the above described embodiment has described an illustrative scenario in which the light-receiving array PI1 is disposed so as to sandwich the light-receiving array PA1 with the light source 121, the light-receiving array PI1 may be disposed between the light-receiving arrays PA1, PA2, as shown in FIG. 14, for example. In this example, the light-receiving arrays PI2L, PI2R are disposed sandwiching the light source 121 in the measurement direction, and the light-receiving array PI1 is disposed further on the centre axis side than the light source 121, between the light source 121 and the light-receiving array PA1. In this modification as well, the light-receiving array PI1 and each of the light-receiving arrays PI2L, PI2R are disposed so that the above described angle θ is substantially 90 degrees, similar to the above described embodiment. Although not shown, in this case, the four slit tracks are disposed in the order of SA1, SI1, SI2, SA2, from the inside toward the outside in the width direction R on the disk 110.

In a case where this configuration is adopted, it is possible to improve the accuracy of signal processing by the stacking-up method, in addition to the same advantages as those in the above described embodiment. That is, the position data generating part 130 calculates a high-resolution absolute position by superimposing the position within one pitch specified based on the high incremental signal of the light-receiving array PI2 onto the absolute position calculated based on the absolute signals of the light-receiving arrays PA1, PA2 and the low incremental signal of the light-receiving array PI1. If signal processing by such a stacking-up method is to be performed more accurately, the phase error between the low incremental signal of the light-receiving array PI1 and the high incremental signal of the light-receiving array PI2 is preferably as small as possible. According to this modification, the light-receiving array PI1 is disposed between the two light-receiving arrays PA1, PA2, thereby making it possible to dispose the light-receiving array PI1 near the light-receiving arrays PI2L, PI2R. Consequently, the mechanical alignment when forming both light-receiving arrays on the substrate BA and when positioning the optical module 120 with respect to the disk 110 becomes relatively easy, making it possible to reduce the displacement of the light-receiving array PI1 and the light-receiving array PI2 compared to a configuration such as the above described embodiment where both light-receiving arrays are separated. As a result, it is possible to reduce the phase error of the signals of the light-receiving array PI1 and the light-receiving array PI2, thereby making it possible to improve the accuracy of the signal processing by the stacking-up method.

### 4-5. Disposing the Light-Receiving Arrays PI1, PI2 on the Inside, and the Light-Receiving Array PI1 in a Divided Manner

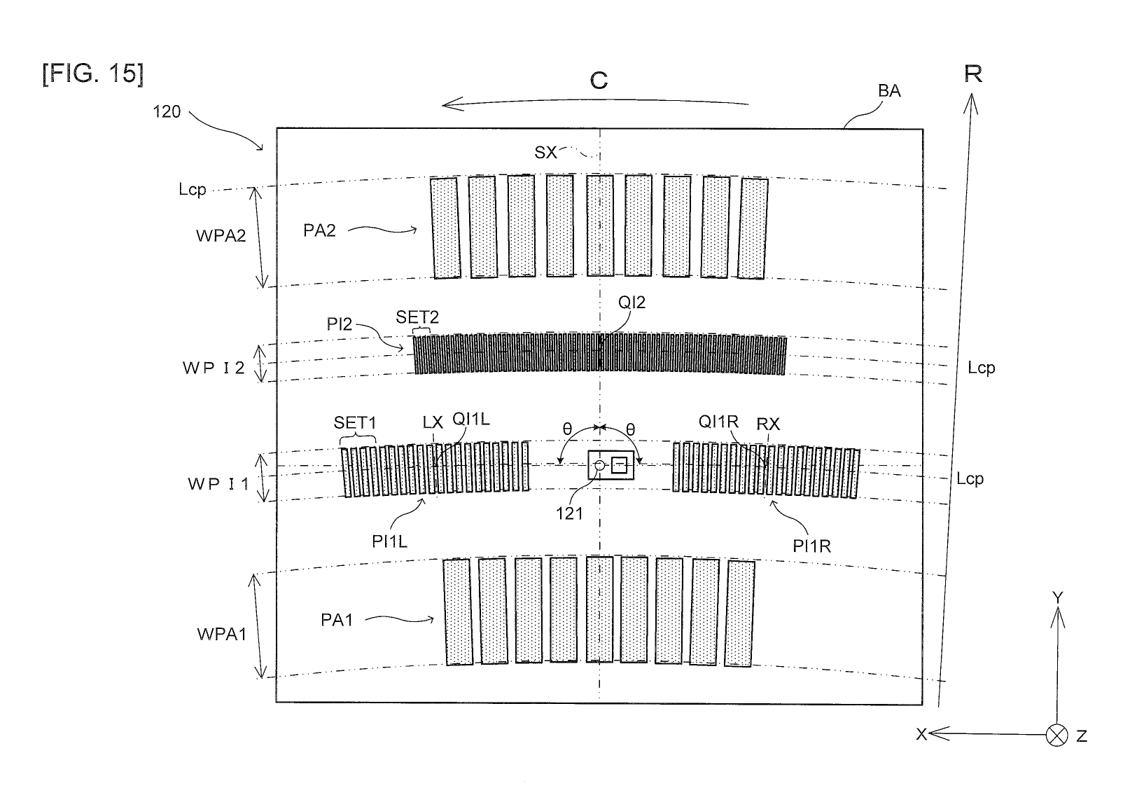

While the above described modification (4-4) has described an illustrative scenario in which the light-receiving array PI2 is divided, sandwiching the light source 121 in the measurement direction, the light-receiving array PI1 may be divided sandwiching the light source 121 in the measurement direction, as shown in FIG. 15, for example. In this case, if the robustness with respect to the eccentricity of the high incremental signal is to be enhanced as in the above described embodiment, a configuration in which the light-receiving array PI2 is disposed further on the side opposite the centre axis than the light source 121 (the outer circumference side), i.e., between the light source 121 and the light-receiving array PA2, is preferably adopted, as shown in FIG. 15. In this case, the light-receiving array PI2 and each of the light-receiving arrays PI1L, PI1R are disposed so that the above described angle θ is substantially 90 degrees. Although not shown, in this case, the four slit tracks are disposed in the order of SA1, SI1, SI2, SA2, from the inside toward the outside in the width direction R on the disk 110. On the other hand, if, conversely to the above, the robustness with respect to the eccentricity of the low incremental signal is to be enhanced, although not shown, a configuration in which the light-receiving array PI2 is disposed further on the centre axis side than the light source 121 (the inner circumference side), i.e., between the light source 121 and the light-receiving array PA1, is preferably adopted. In this case, the four slit tracks are disposed in the order of SA1, SI2, SI1, SA2, from the inside toward the outside in the width direction R on the disk 110.

### 4-6. Disposing the Light-Receiving Arrays PI1, PI2 on the Inside and in a Divided Manner

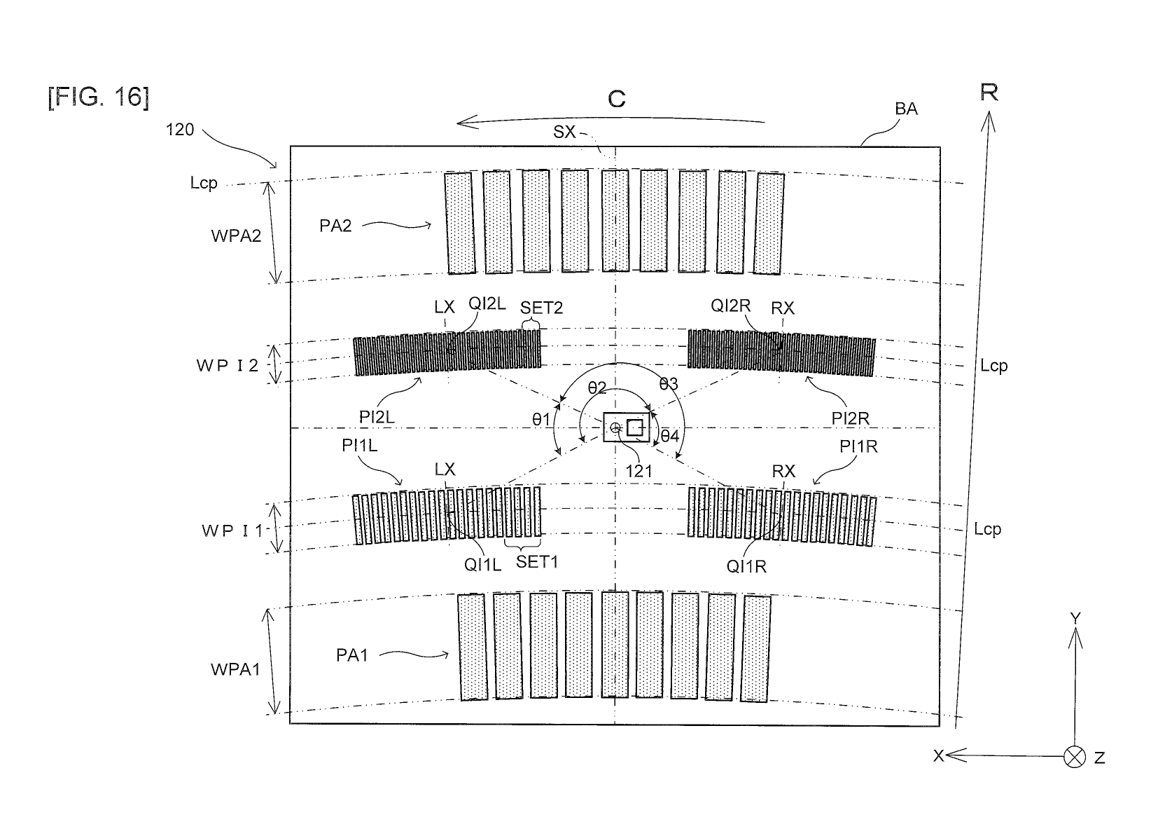

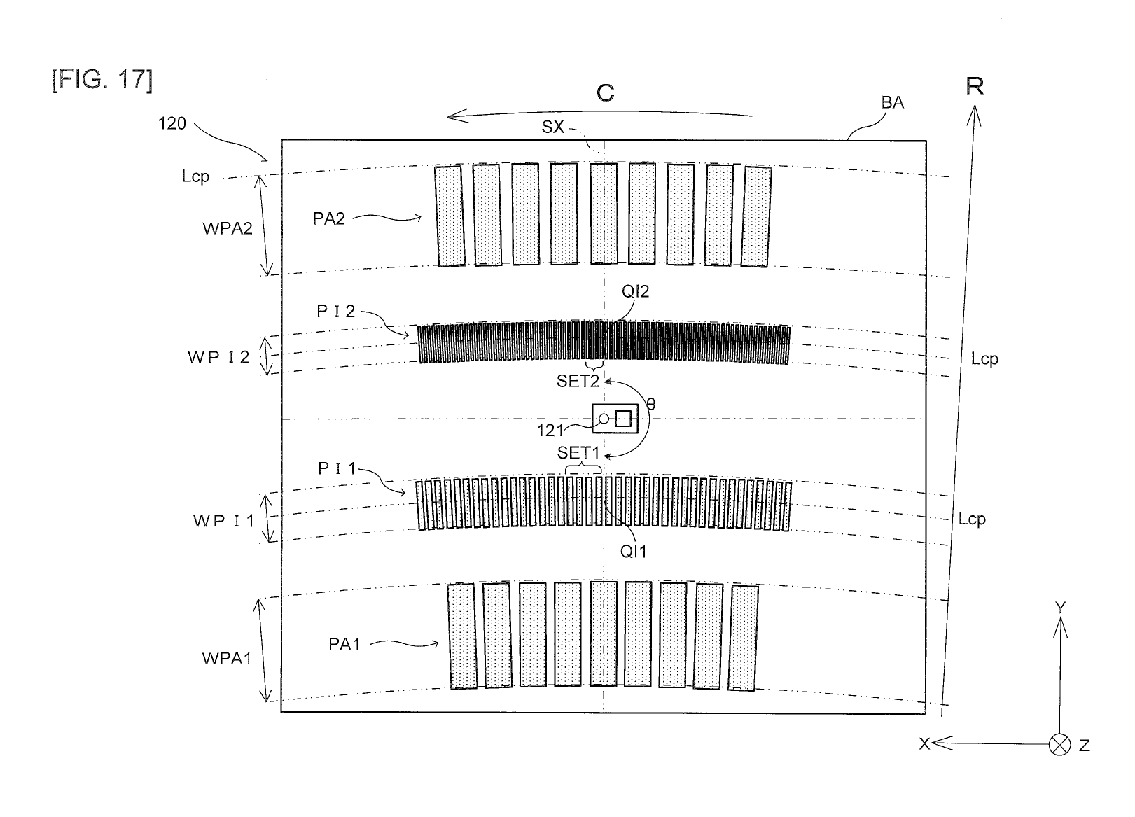

Further, while the above described modifications (4-4) and (4-5) have described cases where only either one of the light-receiving arrays PI1, PI2 corresponding to the incremental pattern is divided sandwiching the light source 121 in the measurement direction, both of the light-receiving arrays PI1, PI2 may be divided sandwiching the light source 121 in the measurement direction, as shown in FIG. 16, for example. The light-receiving arrays PI1L, PI1R are configured to receive the light reflected by the slit track SI1 comprising an incremental pattern of the pitch P1, and the light-receiving arrays PI2L, PI2R are configured to receive the light reflected by the slit track SI2 comprising an incremental pattern of the pitch P2. In this example, the light-receiving arrays PI1L, PI1R and the light-receiving arrays PI2L, PI2R are substantially disposed equidistant from the light source 121. Although not shown, in this case, the four slit tracks are disposed in the order of SA1, SI1, SI2, SA2, from the inside toward the outside in the width direction R on the disk 110.

According to this modification, the disposed area of the light-receiving array PI1 and the disposed area of the light-receiving array PI2 are positioned in directions that differ from each other, with the light source 121 as reference. That is, the light-receiving array PI1L is disposed in an area of a predetermined direction, with the light source 121 as reference (an example of the first direction; the direction of the centre position QI1L of the light-receiving array PI1L in this example), and each of the light-receiving arrays PI2L, PI2R is disposed in an area of a direction that forms the angles θ1, θ2 with respect to the above described predetermined direction, with the light source 121 as reference (an example of the second direction; the direction of the centre position QI2L of the light-receiving array PI2L and the direction of the centre position QI2R of the light-receiving array PI2R in this example). Further, the light-receiving array PI1R is disposed in an area of a predetermined direction, with the light source 121 as reference (an example of the first direction; the direction of the centre position QI1R of the light-receiving array PI1R in this example), and each of the light-receiving arrays PI2L, PI2R is disposed in an area of a direction that forms the angles θ3, θ4 with respect to the above described predetermined direction, with the light source 121 as reference (an example of the second direction; the direction of the centre position QI2L of the light-receiving array PI2L and the direction of the centre position QI2R of the light-receiving array PI2R in this example). According to this modification, as shown in FIG. 16, the light-receiving array PI1L and the light-receiving array PI2R as well as the light-receiving array PI1R and the light-receiving array PI2L are respectively disposed so that the above described angles θ2, θ3 are substantially 180 degrees, and the light-receiving array PI1L and the light-receiving array PI2L as well as the light-receiving array PI1R and the light-receiving array PI2R are respectively disposed so that the above described angles θ1, θ4 are substantially 50 degrees. Note that the above described angle θ is not limited to this as long as it is not 0 degrees.

According to this modification, the light-receiving arrays PI1L, PI1R and the light-receiving arrays PI2L, PI2R are respectively not disposed in the same direction, with the light source 121 as reference (where the above described angle θ is substantially 0 degrees), making it possible to decrease the irregular reflection components respectively mutually received by the light-receiving arrays PI1L, PI2R and the light-receiving arrays PI1R, PI2L based on the intensity distribution shape of the irregular reflection components of the light described above, and suppress the occurrence of crosstalk.

Furthermore, it is possible to collectively dispose all of the light-receiving arrays PI1L, PI1R and the light-receiving arrays PI2L, PI2R near the light source 121, making it possible to improve the responsiveness for both the light-receiving arrays PI1L, PI1R that output low incremental signals, and the light-receiving arrays PI2L, PI2R that output high incremental signals. Further, the distance between the light source 121 and the light-receiving array PI1 and the distance between the light source 121 and the light-receiving array PI2 can be made equal, making it possible to minimize the respective displacement amounts of the light-receiving arrays PI1, PI2 in a case where the optical module 120 is displaced around the optical axis of the light source 121 in the rotating direction. Further, the distance between the light source 121 and the light-receiving array PA1 and the distance between the light source 121 and the light-receiving array PA2 can be made equal, thereby equalizing the displacement amounts of the light-receiving arrays PA1, PA2, and making it possible to eliminate the unbalance of the phase error and minimize the effect on signal processing in a case where the optical module 120 is displaced around the optical axis of the light source 121 in the rotating direction. Consequently, it is possible to improve robustness with respect to displacement of the optical module 120 in the rotating direction.

### 4-7. Disposing the Light-Receiving Arrays PI1, PI2 on the Inside, not in a Divided Manner

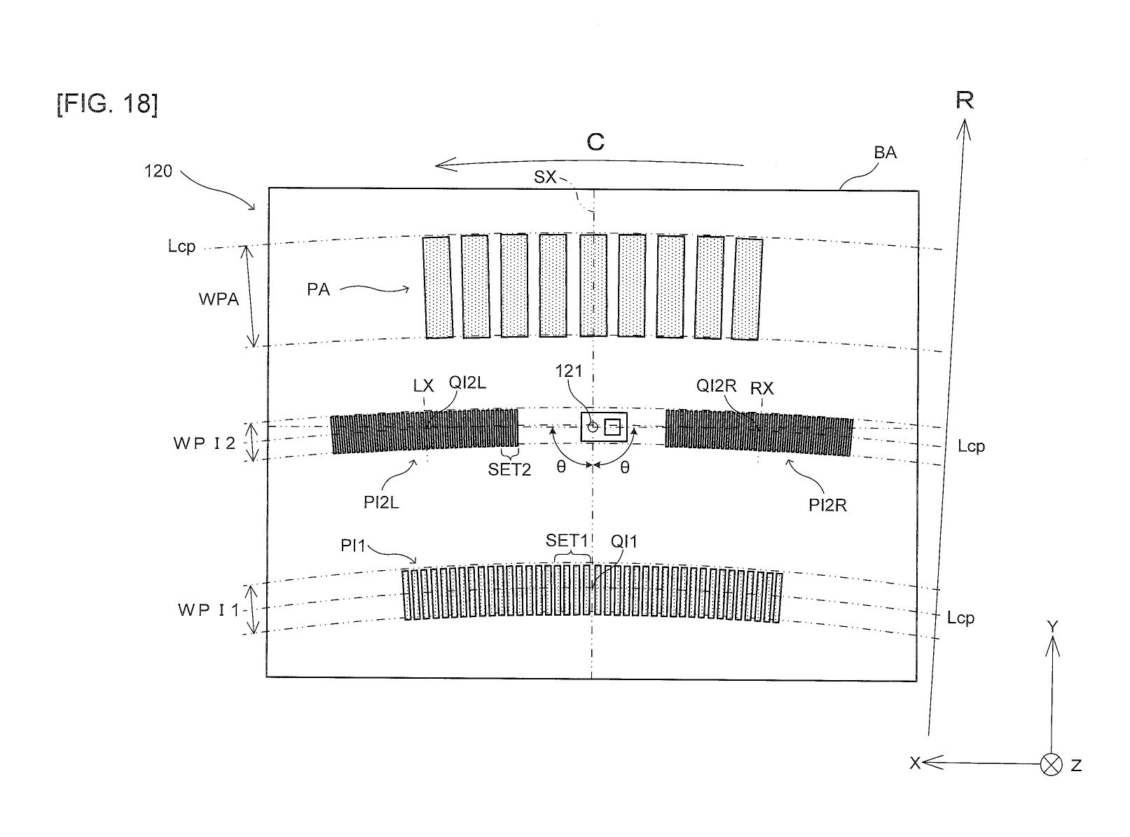

Further, while the above described modifications (4-4) to (4-6) have described cases where at least one of the light-receiving arrays PI1, PI2 corresponding to the incremental pattern is divided sandwiching the light source 121 in the measurement direction, both of the light-receiving arrays PI1, PI2 may be respectively not divided as one light-receiving array, as shown in FIG. 17, for example. The light-receiving array PI1 is configured to receive the light reflected by the slit track SI1 comprising an incremental pattern of the pitch P1, and the light-receiving array PI2 is configured to receive the light reflected by the slit track SI2 comprising an incremental pattern of the pitch P2. In this example, the light-receiving array PI1 and the light-receiving array PI2 are substantially disposed equidistant from the light source 121. Although not shown, in this case, the four slit tracks are disposed in the order of SA1, SI1, SI2, SA2, from the inside toward the outside in the width direction R on the disk 110.

According to this modification, the disposed area of the light-receiving array PI1 and the disposed area of the light-receiving array PI2 are positioned in directions that differ from each other, with the light source 121 as reference. That is, the light-receiving array PI1 is disposed in an area of a predetermined direction, with the light source 121 as reference (an example of the first direction; the negative direction along the Y axis in this example), and the light-receiving array PI2 is disposed in an area of a direction that forms the angle θ with respect to the above described predetermined direction, with the light source 121 as reference (an example of the second direction; the positive direction along the Y axis in this example). According to this modification, as shown in FIG. 17, the light-receiving array PI1 and the light-receiving array PI2 are disposed so that the above described angle θ is substantially 180 degrees.

According to this modification, the above described angle θ is substantially 180 degrees, making it possible to decrease the irregular reflection components respectively mutually received by the light-receiving array PI1 and the light-receiving array PI2 based on the intensity distribution shape of the irregular reflection components of the light described above, and suppress the occurrence of crosstalk. Further, in a case where this configuration is adopted, it is possible to achieve the same advantages as those of the above described modifications (4-4) to (4-6).

4-8. When there is One Light-Receiving Array Corresponding to the Absolute Pattern

While, according to the above described embodiment, the encoder 100 comprises the two slit tracks SA1, SA2 comprising an absolute pattern, as well as the two light-receiving arrays PA1, PA2 configured to respectively receive the light reflected by these slit tracks SA1, SA2, the present disclosure is not limited thereto. For example, as shown in FIG. 18, the optical module 120 may comprise only one light-receiving array PA corresponding to the absolute pattern. Note that the light-receiving array PA is configured in the same manner as the light-receiving array PA2 shown in FIG. 5. In this case as well, the light-receiving array PI1 and each of the light-receiving arrays PI2L, PI2R are disposed so that the above described angle θ is substantially 90 degrees, similar to the above described embodiment. Although not shown, in this case, the three slit tracks are disposed in the order of SI1, SI2, SA, from the inside toward the outside in the width direction R on the disk 110. Note that the slit track SA is configured in the same manner as the slit track SA1 shown in FIG. 4.

In a case where this configuration is adopted, while the number of light-receiving arrays can be decreased, making it possible to reduce the size of the optical module 120, a configuration in which the light-receiving array corresponding to the absolute pattern is disposed in duplicate as in the above described embodiment is preferably adopted in a case where a decrease in the detection accuracy of the absolute position in the area of a change point of the bit pattern is to be avoided, as described above. Note that, in the other modifications (4-1) to (4-7) described above as well, it is possible to have one light-receiving array corresponding to the absolute pattern in the same manner as in this modification.

### 4-9. Other

For example, while the above described embodiment and the like have described cases where the two slit tracks SI1, SI2 comprising incremental patterns that differ in pitch are disposed on the disk 110, three or more slit tracks comprising incremental patterns that differ in pitch may be disposed. In this case as well, it is possible to achieve high resolution by the stacking-up method. At this time, it is also possible to use at least one of the light-receiving arrays PA1, PA2 for the incremental signal, for example.

Further, while the above described embodiment and the like have described cases where each of the light-receiving arrays PA1, PA2 comprises nine light-receiving elements, and the absolute signal represents the absolute position of nine bits, the number of light-receiving elements may be a number other than nine, and the number of bits of the absolute signal is also not limited to nine. Further, the number of the light-receiving elements of the light-receiving arrays PI1, PI2 is also not particularly limited to the number according to the above described embodiments.

Further, while the above described embodiment has described a case where the encoder 100 is directly connected to the motor M, the encoder 100 may be connected via another mechanism, such as a reduction device, rotating direction converter, or the like, for example.

Further, while the above described embodiment has described a case where the light-receiving arrays PA1, PA2 are light-receiving arrays for absolute signals, the present disclosure is not limited thereto. For example, the light-receiving arrays PA1, PA2 may be a light-receiving element group for an origin representing the origin position by the detection signals from the respective light-receiving elements. In this case, the slit tracks SA1, SA2 of the disk 110 are formed comprising an origin pattern. Then, the bit pattern and intensity of the light reception signals from the light-receiving arrays PA1, PA2 represent the origin position.

What is claimed is:

1. An encoder, comprising:
a plurality of slit tracks that respectively comprise a plurality of reflection slits arranged along a measurement direction;
a point light source configured to emit diffusion light to the plurality of slit tracks;
a first light-receiving array that is configured to receive light reflected by the slit track comprising an incremental pattern, and is disposed at a position in a first direction than the point light source; and
a second light-receiving array that is configured to receive light reflected by the slit track comprising an incremental pattern that differs in pitch from the slit track corresponding to the first light-receiving array, and is disposed at a position in a second direction than the point light source, the second direction forming an angle θ with respect to the first direction.

2. The encoder according to claim 1, wherein:
the first light-receiving array and the second light-receiving array are disposed in the manner that the second direction inclines with respect to the first direction.

3. The encoder according to claim 2, wherein:
the first light-receiving array and the second light-receiving array are disposed in the manner that the angle θ is substantially 90 degrees.

4. The encoder according to claim 1, wherein:
either one of the first light-receiving array and the second light-receiving array is divided sandwiching the point light source.

5. The encoder according to claim 2, wherein:
either one of the first light-receiving array and the second light-receiving array is divided sandwiching the point light source.

6. The encoder according to claim 3, wherein:
either one of the first light-receiving array and the second light-receiving array is divided sandwiching the point light source.

7. The encoder according to claim 1, further comprising a third light-receiving array that is configured to receive light reflected by the slit track comprising an absolute pattern, and is disposed between either one of the first light-receiving array and the second light-receiving array, and the point light source.

8. An encoder, comprising:
a plurality of slit tracks that respectively comprise a plurality of reflection slits arranged along a measurement direction;
a point light source configured to emit diffusion light to the plurality of slit tracks;
a plurality of first light-receiving arrays configured to respectively receive light reflected by a plurality of the slit tracks respectively comprising incremental patterns that differ in pitch; and
a second light-receiving array that is configured to receive light reflected by the slit track comprising an absolute pattern, and is disposed between any one of the plurality of first light-receiving arrays and the point light source.

9. The encoder according to claim 1, wherein:
the point light source as well as the first light-receiving array and the second light-receiving array are disposed on one substrate.

10. The encoder according to claim 8, wherein:
the point light source as well as the first light-receiving array and the second light-receiving array are disposed on one substrate.

11. An encoder, comprising:
a plurality of slit tracks that respectively comprise a plurality of reflection slits arranged along a measurement direction;
means for emitting diffusion light to the plurality of slit tracks;
means for receiving light reflected by the slit track comprising an incremental pattern, disposed at a position in a first direction than the point light source; and
means for receiving light reflected by the slit track comprising an incremental pattern that differs in pitch from the slit track corresponding to the means for receiving light reflected by the slit track comprising the incremental pattern, disposed at a position in a second direction than the point light source, the second direction forming an angle θ with respect to the first direction.

12. A motor with an encoder, comprising:
a linear motor wherein a mover moves with respect to a stator, or a rotary motor wherein a rotor rotates with respect to a stator; and
the encoder according to claim 1 configured to detect at least one of a position and a velocity of the mover or the rotor.

13. A motor with an encoder, comprising:
a linear motor wherein a mover moves with respect to a stator, or a rotary motor wherein a rotor rotates with respect to a stator; and
the encoder according to claim 8 configured to detect at least one of a position and a velocity of the mover or the rotor.

14. A servo system comprising:
a linear motor wherein a mover moves with respect to a stator, or a rotary motor wherein a rotor rotates with respect to a stator;
the encoder according to claim 1 configured to detect at least one of a position and a velocity of the mover or the rotor; and
a controller configured to control the liner motor or the rotary motor based on a detection result of the encoder.

15. A servo system comprising:
a linear motor wherein a mover moves with respect to a stator, or a rotary motor wherein a rotor rotates with respect to a stator;
the encoder according to claim 8 configured to detect at least one of a position and a velocity of the mover or the rotor; and
a controller configured to control the liner motor or the rotary motor based on a detection result of the encoder.
